(19) United States
(12) Patent Application Publication
(10) Pub. No.: US 2020/0210949 A1
(43) Pub. Date: Jul. 2, 2020

(54) Shipment Tracking Systems and Methods

(71) Applicants: Matthew Mugar, Culver City, CA (US); Walter Lopes, Culver City, CA (US)

(72) Inventors: Matthew Mugar, Culver City, CA (US); Walter Lopes, Culver City, CA (US)

(21) Appl. No.: 16/730,383

(22) Filed: Dec. 30, 2019

Related U.S. Application Data
(60) Provisional application No. 62/787,197, filed on Dec. 31, 2018.

(51) Int. Cl. G06Q 10/08; H04L 12/58

(52) U.S. Cl. CPC G06Q 10/0833; G06Q 10/0875; H04L 51/046; G06Q 10/0835; G06Q 10/0838; G06Q 10/0832

(57) ABSTRACT

Systems or methods include providing, by a server computer, a shipper application configured to store shipment related information and the shipper application configured to send shipment information to the server computer. The method includes, receiving, by the server computer, the shipment related information having one or more types of items, and a total number of items being shipped, generating a UI based on the total number and types of items to capture one or more shipper images of one or more items in a shipping package prior to the one or more items being shipped to a receiver, receiving, by the server computer, the shipper images, and providing a recipient application that is configured to capture one or more recipient images of the one or more items in the shipping package to capture the condition of the one or more items after being shipped to a recipient.

### CROSS REFERENCES TO RELATED APPLICATIONS

This application claims the benefit of U.S. Provisional Patent Application No. 62/787,197, filed Dec. 31, 2018, entitled as “Shipment Tracking Systems and Methods”, which is incorporated herein by reference in its entirety.

### BACKGROUND

Various industries continue to modernize their operations using proliferated technologies. However, there continues to be a lack of transparency in the package delivery, shipping, trucking industries between various parties, such as but not limited to, shippers, freight operators, freight brokers, recipients and customers. Currently, cameras for taking high quality images have become ubiquitous on mobile devices. Embodiments discussed in greater detail below disclose the use of images with various processes in order to provide additional transparency to the parties involved in various industries.

### SUMMARY

Embodiments are directed to various industries that transport goods internationally and domestically. Some industries include, but are not limited to trucking, ocean cargo, rail, freight, international manufacturing, foot transportation, personal airfare for luggage, small parcel delivery or the like.

Embodiments are directed to a method for verifying a shipment, the method includes, providing, by a server computer, a shipper application configured to store shipment related information and the shipper application configured to send shipment information to the server computer, and receiving, by the server computer, the shipment related information comprising one or more types of items, and a total number of items being shipped. The method further includes, generating one or more user interfaces based on the total number and types of items to capture one or more shipper images of one or more items in a shipping package prior to the one or more items being shipped to a receiver, and receiving, by the server computer, the one or more shipper images and the shipment related information. The method may include providing, by the server computer, a recipient application that is configured to capture one or more recipient images of the one or more items in the shipping package to capture the condition of the one or more items after being shipped to a recipient.

Various embodiments of the method include providing the one or more shipper images to the recipient application to permit the recipient to compare with the condition of the one or more items after being shipped to the recipient and sending the shipment information and the shipper images to the server computer subsequent to a shipper user device connecting to a Wi-fi network.

Various embodiments include receiving by a server computer the one or more recipient images. In some embodiments, the server computer may be configured to compare the one or more shipper images with the one or more recipient images. Various embodiments include the recipient images being received only by the server computer when a recipient user device is connected to a Wi-Fi network. The method includes the shipment information being stored on a shipper device prior to the shipper device connecting to a Wi-Fi network. The shipping package may be at least one of a box, pallet or container.

Embodiments include an apparatus for verifying a shipment, the apparatus including a user device with a shipper application, provided by a server computer system, that is configured to receive shipment related information to send to a server computer system and the shipment related information including one or more types of items, a total number of items being shipped and one or more shipper images of one or more items that are part of the shipment. The apparatus may have an image capture device communicatively coupled to the user device to capture the one or more shipper images of the one or more items. The apparatus may include a shipper application that is configured to store at least a portion of the shipment related information on the user device until the user device is connected to a Wi-Fi network.

Embodiments include the user device being configured to transfer the shipper images only after the user device is connected to the Wi-Fi network. It further includes the user device being configured to transfer textual shipment related information to the server computer system via cellular network before connecting to the Wi-Fi network. The apparatus includes the user device being configured to transfer text data related to the shipper images via a cellular network as the images are captured. The apparatus includes the user device being configured to transfer the shipper images only when the user device is connected to the Wi-Fi network. The apparatus may include a recipient user device having a recipient application that is configured to receive the shipper images in order to compare the shipper images to the items that were shipped. The recipient user device having a recipient application is configured to capture images of the shipment upon receipt of the shipment. The server computer of the apparatus may be configured to compare the one or more shipper images with the one or more recipient images.

Embodiments are directed to a method that includes providing, by a server computer, a shipper application configured to store shipment related information and send shipment information to a server when the user device is connected to a Wi-Fi network, receiving, by the server computer, the shipment related information comprising one or more types of items, and a total number of items being shipped, generating one or more user interfaces based on the total number and types of items to capture one or more shipper images of one or more items in a shipping package prior to the one or more items being shipped to a receiver. The method further includes receiving, by the server computer, the one or more shipper images and the shipment related information and providing, by the server computer, a recipient application that is configured to capture one or more recipient images of the one or more items in the shipping package to capture the condition of the one or more items after being shipped to a recipient.

The method may include providing an application to a user device wherein the application is configured to store shipment related information on the user device to be uploaded to a server subsequent to all required fields of the shipment information being received on the user device. The shipping package may be at least one of a box, pallet or container. The method further includes providing the one or more shipper images to the recipient application to permit the recipient to compare with the condition of the one or more items after being shipped to the recipient.

### BRIEF DESCRIPTION OF THE FIGURES

The details of one or more implementations are set forth in the accompanying drawings and the description below. Other features, aspects, and advantages of the disclosure will become apparent from the combination of the description, the drawings, and the claims in which:

FIG. 1 is a schematic diagram of a computer-implemented shipment verification system according to an embodiment.

FIG. 2 is an example process implemented by the shipment verification system of FIG. 1.

FIG. 3 illustrates an architecture diagram of the app server shown in FIG. 1.

FIG. 4 is an example process implemented by the shipment verification system of FIG. 1.

FIG. 5 is an example process implemented by the shipment verification system of FIG. 1.

FIG. 6 is an example process implemented by the shipment verification system of FIG. 1.

FIG. 7 is an example process implemented by the shipment verification system of FIG. 1.

FIG. 8 is an example process implemented by the shipment verification system of FIG. 1.

FIG. 9A is a user interface display of an application implemented using the system shown in FIG. 1.

FIG. 9B is a user interface display of an application implemented using the system shown in FIG. 1.

FIG. 10 is a user interface display of an application implemented using the system shown in FIG. 1.

FIG. 11A is a user interface display of an application implemented using the system shown in FIG. 1.

FIG. 11B is a user interface display of an application implemented using the system shown in FIG. 1.

FIG. 12A is a user interface display of an application implemented using the system shown in FIG. 1.

FIG. 12B is a user interface display of an application implemented using the system shown in FIG. 1.

FIG. 12C is a user interface display of an application implemented using the system shown in FIG. 1.

FIG. 12D is a user interface display of an application implemented using the system shown in FIG. 1.

FIG. 12E is a user interface display of an application implemented using the system shown in FIG. 1.

FIG. 12F is a user interface display of an application implemented using the system shown in FIG. 1.

FIG. 12G is a user interface display of an application implemented using the system shown in FIG. 1.

FIG. 13A is a user interface display of an application implemented using the system shown in FIG. 1.

FIG. 13B is a user interface display of an application implemented using the system shown in FIG. 1.

FIG. 14A is a user interface display of an application implemented using the system shown in FIG. 1.

FIG. 14B is a user interface display of an application implemented using the system shown in FIG. 1.

FIG. 15A is a user interface display of an application implemented using the system shown in FIG. 1.

FIG. 15B is a user interface display of an application implemented using the system shown in FIG. 1.

FIG. 16A is a user interface display of an application implemented using the system shown in FIG. 1.

FIG. 16B is a user interface display of an application implemented using the system shown in FIG. 1.

FIG. 17A is a user interface display of an application implemented using the system shown in FIG. 1.

FIG. 17B is a user interface display of an application implemented using the system shown in FIG. 1.

FIG. 18A is a user interface display of an application implemented using the system shown in FIG. 1.

FIG. 18B is a user interface display of an application implemented using the system of FIG. 1.

FIG. 18C is a user interface display of an application implemented using the system of FIG. 1;

FIG. 18D is a user interface display of an application implemented using the system of FIG. 1.

FIG. 19A is a user interface display of an application implemented using the system shown in FIG. 1.

FIG. 19B is a user interface display of an application implemented using the system shown in FIG. 1.

FIG. 20A is a user interface display of an application implemented using the system shown in FIG. 1.

FIG. 20B is a user interface display of an application implemented using the system shown in FIG. 1.

FIG. 21 is a user interface display of an application implemented using the system shown in FIG. 1.

FIG. 22A is a user interface display of an application implemented using the system shown in FIG. 1.

FIG. 22B is a user interface display of an application implemented using the system shown in FIG. 1.

FIG. 23A is a user interface display of an application implemented using the system shown in FIG. 1.

FIG. 23B is a user interface display of an application implemented using the system shown in FIG. 1.

FIG. 24A is a user interface display of an application implemented using the system shown in FIG. 1.

FIG. 24B is a user interface display of an application implemented using the system shown in FIG. 1.

### DETAILED DESCRIPTION

The following business case shows an example of how the systems and methods described herein may be used. The systems that may be used for the applications described herein may include a central processor with one or more processing cores, Random Access Memory, permanent memory, non-transitory storage media, and/or remotely located non-transitory storage media.

Goods are shipped via airplanes, ships, trucks, vans, cars or the like both internationally and domestically by one or more entities. Various entities such as manufacturers, shippers, distributors, brokers, logistic companies, insurance companies, truckers and trucking companies, retail companies, online retailers, warehouse companies, consumers, delivery companies or the like are each involved in a semi-coordinated manner in the delivery ecosystem of transported goods. Each of the above entities desires greater transparency, current status of the shipment of packages in transit and the condition of the package or shipment when the package is packed, or when the package reaches a pre-determined location when and how the package is transported or repackaged.

Sometimes packages are damaged in transit and it may be challenging to determine the cause of the damage or where in transit the package may have been damaged. Moreover, even when it is readily determined where and when the damage occurred, it may be challenging to gather the appropriate documentation and to determine which insurance company to contact. Packages or shipments may be damaged for various reasons such as, but not limited to, lack of export packaging, increased use of weak retail packaging, inadequate ventilation, wrong choice of container, poor condition of container, and ineffective sealing arrangements, ineffective internal cleaning, contaminated floors (taint), wrong temperature settings, condensation, overloading, poor distribution of cargo weight, wrong air flow settings, wrongly declared cargo, B/L temperature notations misleading/unachievable, lack of reefer points, heavy containers stowed on light, stack weights exceeded, heat sensitive cargoes stowed on/adjacent to heated bunker tanks or in direct sunlight, fragile cargoes stowed in areas of high motion, damaged, worn, mixed securing equipment, poor temperature monitoring, improper temperature controls or the like. Many of the above listed reasons for damage to a package can be detected or prevented by taking one or more images of the package, its surroundings and container after one or more items or packages are loaded into a container. Additionally, the images may be analyzed using visual inspection or by using an artificial intelligence or machine learning algorithm to avoid and/or prevent the reasons for package damage all together. In particular, an AI/machine learning algorithm may receive data (including images) regarding multiple damaged packages and the reason for the damage to the package and assemble a model to detect same or similar issues for other packages with similar issues.

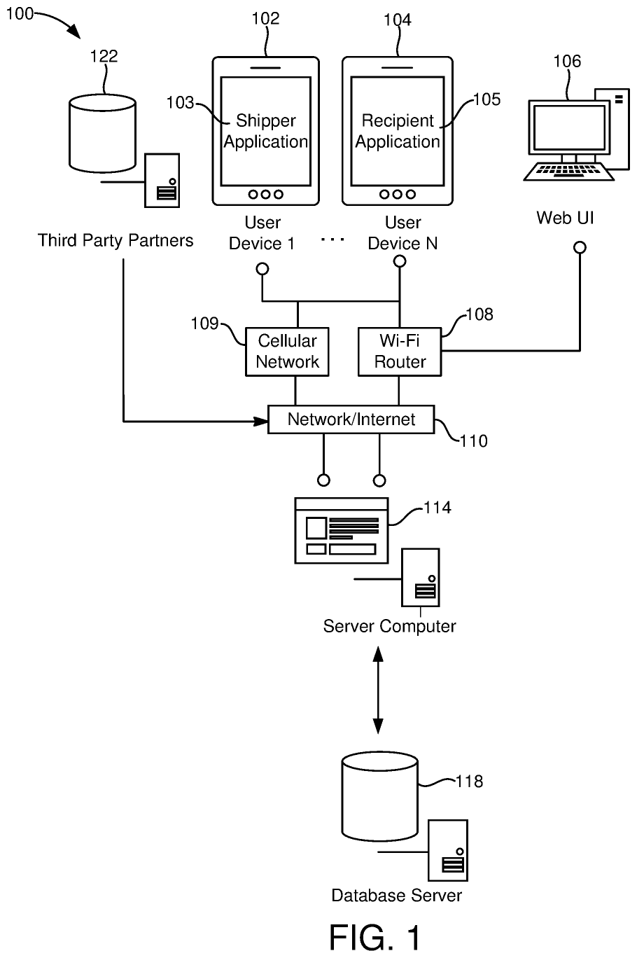

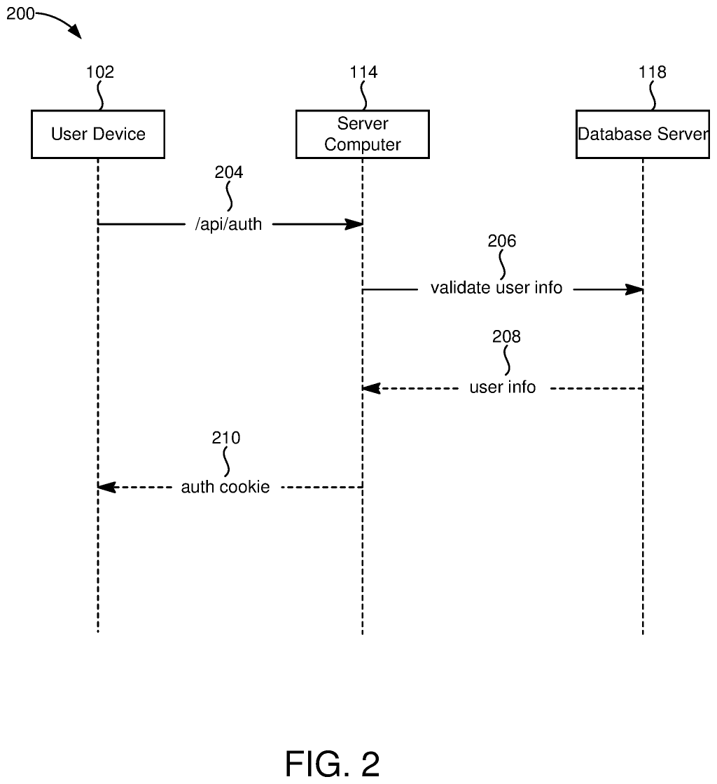

Referring to FIG. 1, FIG. 1 is a schematic diagram of a computer-implemented shipment verification system 100 in accordance with an embodiment. The shipment verification system 100 includes among other systems, a user device 102, a user device 104, a user device 106, a Wi-Fi router 108, a cellular network 109, a network 110, an application server 114, a database server 118 and a third-party server 122. Each of the above devices and systems may communicate with each other via a network 110 or other means. In various embodiments, the network 110 may include one or more of the Internet, Ethernet, cellular network, Wi-Fi, LTE, 4G, 3G, Wi-Max, a proprietary shipment verification network, a proprietary shipment tracking network, and so on. The user device 102, user device 104, user device 106, application server 114, third party server 122 and database server 118 may each comprise a computer system each with one or more processors configured to execute instructions, send and receive data, stored in one or more non-transitory storage media or memory, and perform other operations to implement the operations described herein associated with processes and user interfaces shown in FIGS. 2 through 24B.

The user devices 102, 104, 106 may, for example be, a cellular phone, mobile handheld wireless device, smart phone, personal digital assistant, tablet computers, laptop computer, desktop computer, portable gaming device, a specifically designed device or other suitable devices for capturing shipment related information. The user device 102 may include a processor in communication with one or more memory systems. The user device 110 may also include a wired and/or wireless transmitter and receiver for communicating with one or more networks, for example, network 110. In various embodiments, a user may be in possession of the mobile device 102 when preparing a shipment to be shipped or receiving a shipment that has been shipped in a warehouse. In various embodiments, the user device 102 may be specifically configured to receive and send one or more shipment related information to and/or from third party server 122 and/or database server 118. In various embodiments, although only three user devices 102, 104, and 106 are displayed in FIG. 1, the shipment verification system 100 may include numerous user devices from user device 1 to user device N as shown in the FIG. 1. The user devices 102, 104 and 106 may be configured to connect to various networks including but not limited to network 110. In some embodiments, the user devices 102 and 104 may be a mobile device that is capable of both 802.11x communication using a Wi-Fi router 108 that is communicatively connected to a Network or the Internet. Throughout this disclosure a single user device may be mentioned, however, each and every user device 102, 104 or 106 are capable of performing any of the functions that any user device may be programmed to perform.

In some embodiments, the user devices 102 and 104 may be mobile devices that can communicate information using a cellular antenna (such as but not limited to Edge, GSM, 2G, 3G, LTE, 4G, 5G, other network communication protocols or the like). Depending on the user's location, communication via a cellular antenna may be attenuated and the user may not be able to transmit high resolution images without interrupting the work flow.

In some embodiments, certain applications such as but not limited to a shipper application 103 and/or a recipient application 105 may be configured to not send any data regarding shipment related information while the user devices 102 and 104 are unable to access a Wi-Fi router 108 with a live network connection to the network 110. In other embodiments, a shipper application 103 and/or a recipient application 105 may be configured to send a limited amount or type of data while having a cellular connection and while not being connected to a Wi-Fi router 108. Limited amount or type of data may include but is not limited to numerical, textual, GPS coordinates, number of items, type of items, shipper information, receiver information or the like. Limited data may include enough information to create a unique identifier in the database server 118. The limitation on the amount of data being transferred to the server computer 114 while the package is being loaded is primarily to permit the user to do their job on the user device 102 and 104 while gathering the required details. Accordingly, the bandwidth or the data transfer rate may determine how much data and the type of data that is transferred. In some embodiments, there may be a sliding scale for the amount of data and the type of data that is transferred while on a cellular network. In some embodiments, the sliding scale refers to the fact that when the data transfer rate is higher more data may be transferred to the server computer 114. Similarly, when the data transfer rate is lower less data may be transferred to the server computer 114. For example, in some embodiments, if the cellular network speed is 1 Mbps, then only the unique identifier for the shipment record may be transmitted. In some embodiments, if the cellular network speed is higher, such as 2 Mbps, then the unique identifier and the type of units may be transferred via the cellular network. Similarly, if the speed is 3 Mbps, the total number of pieces may also be transmitted to the server computer 114. Accordingly, the sliding scale may increase the number of items, type of data based on the cellular data connection speed. The shipper application 103 and recipient application 105 may be configured to detect the cellular data connection speed and are configured to store the information in a local databased on the user devices 102 and the user device 104 and transmit shipment related information without interrupting or slowing down the process of the applications 103 and 105 for the user.

Accordingly, in some embodiments, certain applications such as but not limited to a shipper application 103 and/or a recipient application 105 may be configured to send portions (e.g. textual data, etc.) of the shipment related information to the server computer 114 while being connected to a cellular network 109. In various embodiments, the applications may configure the user devices 102 and 104 to wait to transmit images (high and/or low resolution) until the user devices 102 and/or 104 are connected to a Wi-Fi router 108 (high speed network) or user device 106 that is capable of connecting to a hardwired router.

In various embodiments, the shipper application 103 and recipient application 105 may be part of a single application that may be used by both shippers and by recipients. Moreover, the applications 103 and 105 may store a data record or access a data record of all packages that have been shipped and all packages that are in transit. In other embodiments, the server computer 114 may store the data records relating to all packages that have been shipped and all packages that are in transit.

The server computer 114 may allow a third-party server 122 to communicate with user device 102, user device 104 and user device 106. In other embodiments, the server computer 114 may be an application user interface that allows other computer systems to connect with the database server 118 and other computer systems shown or not shown in FIG. 1. In other embodiments, the server computer 114 may be configured to request additional data, documents, insurance documents, permits and other required data for the shipper and/or the recipient. The server computer 114 may be configured to communicate with the user devices 102, 104 and 106. The server computer 114 may receive shipment related information from the user device 102, 104 and 106 when the user devices are connected to the Wi-Fi router 108.

The database server 118 may be a single or multiple distributed computer system that is configured to communicate with all computer systems and devices shown or not shown in FIG. 1. The database server 118 may receive and send shipment related information from and to the shipper application 103 and the recipient application 105. In various embodiments, the database server 118 may only receive limited information while the shipper application 103 is connected to the cellular network. In other embodiments, the database server 118 may receive images and all other shipment related information when the shipper application 103 or the recipient application 105 is connected to a Wi-Fi router 108 that connects the user devices 102 and/or 104 to the Internet with a high-speed network.

Third party server 122 may be owned by one or more third parties that offer services or receive services from the shipper or the recipient. The third-party server 122 may be configured to access the database server 118 via the server computer 114. The third-party servers 122 may upload documents related to one or more shipments. In some embodiments, the shipper application 103 may ping a known third party server 122 and request documents from the third-party server 122 relating to a newly created shipment.

FIG. 2 is an example authentication process 200 implemented by the shipment verification system 100 in accordance with FIG. 1. In various embodiments, at step 204, an API/authentication request may be received by the server computer 114 from the shipper application 103 provided to the user device 102 by the server computer 114. The API/authentication request may include a username and password that are transmitted to the server computer 114. In some embodiments, the authentication request may be sent using a cellular network 109. In other embodiments, the authentication request may be sent using a Wi-Fi router 108. In some embodiments, once the user has been authenticated in a single day, no further authentication may be required until the user connects back with the Wi-Fi Router 108. In some embodiments, the username may be the user's email address, or a user selected unique login name.

At step 206, the server computer 114 may validate the user information by transmitting the username and password to the database server 118. In various embodiments, the database server 118 may load the user's information from the database using the username (e.g. user's email address or the like). The database server 118 may be configured by the server computer 114 to run a hash function on the provided password and check the hash against the hash stored in the database.

At step 208, after verifying the username and password, the user information is sent back to the server computer 114 that can generate an authentication cookie at step 210. Step 210 further includes transmitting the authentication cookie back to the user device 102, after generating the authentication cookie. In step 210, the server computer 114 sets the authentication cookie using a cookie header and returns the user's information in a json-format inside the response's body. In various embodiments, the authentication process 200 may be used by various user devices such as but not limited to user device 104 and user device 106.

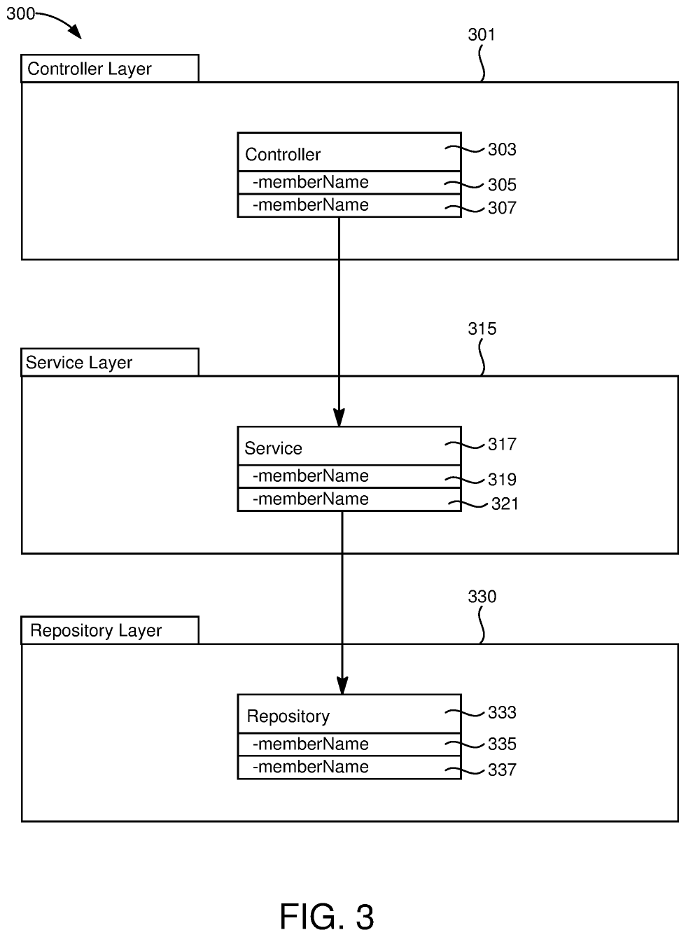

FIG. 3 illustrates the architecture diagram 300 of the server computer 114. In some embodiments, the server computer 114 may be built using a layered architecture. Other suitable architectures that allow the systems 100 to realize the advantages discussed herein may also be used. The architecture diagram 300 includes a controller layer 301, a service layer 315 and a repository layer 330. In some embodiments, different layers are used to split HTTP logic from the business logic and from the database logic. The controller layer 301 includes a controller 303 with one or more member names 305 and 307. The controller layer 301 may have controllers which are mainly used to serialize or deserialize data from json-format and handle HTTP specific details, such as but not limited to, HTTP headers, cookies, etc. The service layer 315 includes, but is not limited to, a service 317 with one or more member names 319 and 321. The service layer 315 performs the functions of the business logic. Each service encapsulates parts of the business logic. Example business logic that may be managed by the service layer 315 includes a shipment service which holds shipment workflow. The repository layer 330 includes a repository 333 with member names 335 and 337. In various embodiments, the repository layer 330 holds database specific logic. In some embodiments, all the database queries and data manipulation may be managed by the repository layer 330. As shown in architecture diagram 300, upon determining that a request is for business logic or database specific inquiry the query may be transferred to the service layer 315. In various embodiments, the service layer 315 will in turn transfer the all database related inquires to the repository layer 330.

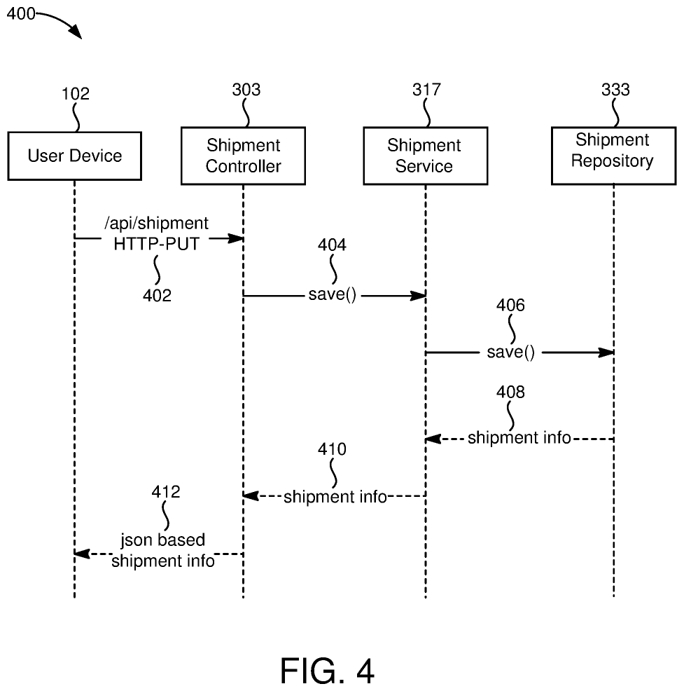

FIG. 4 illustrates a process 400 for creating a new shipment using a user device 102 and a shipper application 103. The process 400 shows communications between the client-side device such as, but not limited to, the user device 102 and server computer 114. Moreover, the process 400 shows the communication between different layers within the server computer 114. For example, at step 402 the user device 102 may send a request to update shipment information to the shipment controller 303 of the server computer 114. In some embodiments, the request may be sent as a HTTP-put request or similar type of request. In various embodiments, details regarding the shipment that are passed in the body of the request are serialized into json-format. At step 404, the shipment controller verifies that user is authenticated and authorize that user can update one or more shipment. The shipment controller 303 may deserialize data from json into shipment object and transfer the data to shipment service 317. At step 406 shipment service applies business rules and sends the data to shipment repository. At step 408, shipment repository 333 may save data to the database and returns shipment information together with a shipment identifier. At step 410, service returns data to controller. At step 412, the controller may serialize the data to json data type and returns the data to user device 102.

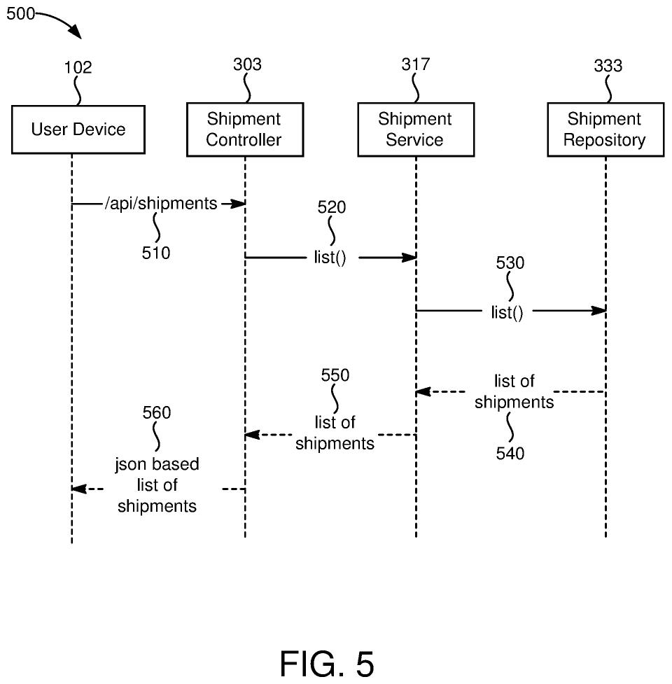

FIG. 5 illustrates a sequence diagram showing a process 500 for requesting a list of shipments from a user device 102. At step 510, the user device 102 may send an http-get request to /api/shipments endpoint to get a list of shipments from the shipment controller 303 of server computer 114. The request in step 510 may contain filters or criteria for the list such as but not limited to all shipments/sent shipments/receive shipments and search criteria. At step 520, the shipment controller 303 (server computer 114) validates that the user is authenticated and authorized to receive the list of shipments. The shipment controller 303 may send a list request to the shipment service 317 by passing filters and criteria together with the username (user's e-mail address or the like). At step 530, the shipment service 317 may request a list of shipments by using email providing filters and criteria. At step 540, the shipment repository 333 may load data from the database by using the user's username (e.g., user's email address), provided filters and criteria as a query. At step 540, the shipment repository 333 loads the data from the database by user's email using provided filters and criteria. At step 550, the shipment service 317 applies the necessary business rules and returns a list of shipments to the controller 303. At step 560, the controller 303 may serialize the list of shipments to json format and returns the shipments list to be displayed on a user device 102 via shipper application 103 or the recipient application 105.

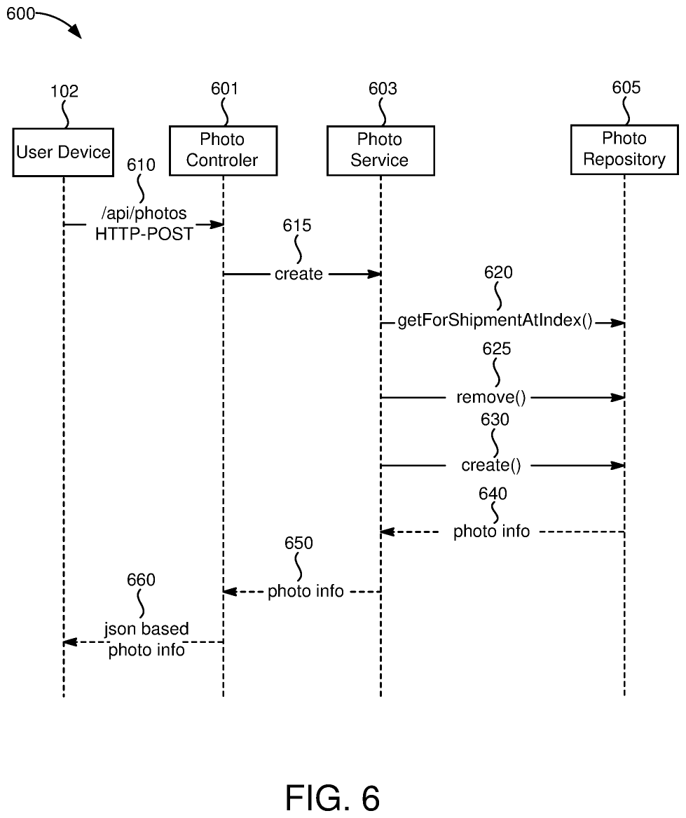

FIG. 6 illustrates a sequence diagram in a process 600 for uploading photographs relating to one or more shipments. In various embodiments, the user device 102 may be programmed by the server computer 114 to upload photographs only when the user device 102 is connected via a Wi-Fi router 108. In various embodiments, the user device 102 may be programmed by the server computer 114 to upload information regarding the photographs, such as but not limited to, the number of photographs, GPS location of the photographs and all other metadata regarding the photographs when the user device 102 is connected to the network 110 via a cellular network 109. In this embodiment, the user device 102 may delay uploading the image itself until the user device 102 connects to the Wi-Fi router 108. Accordingly, there may be two different time periods for uploading image related data and the images themselves. At a first time period, while having a cellular connection using a cellular network 109 the user devices (102, 104 and 106) may upload image related data (image metadata). In a second time period, subsequent to the first time period, the user devices (102, 104 and 106) may upload the images and any additional image related metadata that was not uploaded during the first time period to the server computer 114.

The process 600 illustrates the method by which the user device 102 may be programmed by the server computer 114 to upload images when the user device 102 is connected to the network 110 via Wi-Fi router 108. At step 610, the user device 102 may send all photographs related to a shipment in the shipper application 103 or the recipient application 105 to a photo controller 601 using for example, an HTTP-Post request to /api/photos endpoint. The image and related shipment information (Photo type, Order, identifier) are included in the body of the request. At step 615, the photo controller 601 may store the one or more photographs into proper folder in the database server 118 and send photo information to photo service. If a photo doesn't exist in the photo repository 605, then the photo service 603 creates a new photo for the shipment in the photo repository at step 630. If the photograph for this position already exists, then it is removed at step 625 and then a new photo is stored in the photo repository 605. The photo repository 605 may implement the following set of operations, at step 620, the function getForShipmentAtIndex may return photo information by index. At step 625, the photo repository 605 may remove information about the image and the photograph from the database server 118. At step 630 the photo server 603 may request the photo repository 605 to create an image location and save the information about the images to the database server 118. At step 640, the photo repository 605 may return information about the saved images including photo identifier to the photo server 603. At step 650, the photo service 603 may return photo information to the photo controller 603. At step 660, photo controller 603 serializes the data into a json format and sends the data back to the user devices (102, 104 or 106).

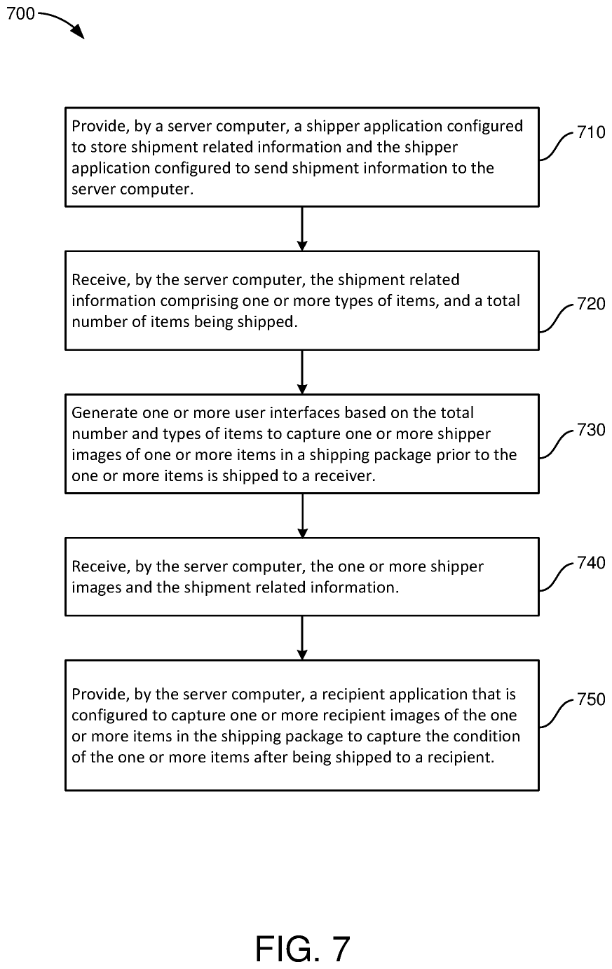

FIG. 7 illustrates a process 700 that may be implemented by the system shown in FIG. 1. At step 710, a server computer 114 may provide a shipper application 103 that is configured to store shipment related information. The shipper application 103 may be configured to send shipment information to the server computer 144. In some embodiments, the shipper application 103 may be executed by one or more user devices 102, 103 and 106. The shipment related information may include a unique shipment reference number, type of units (pallets, rolls, package, etc.), number of units, shipper information, company name, address, receiver information, company name and address, images of every unit, images of the loaded units or freight, bill of lading documents, and insurance related documents or the like. In some embodiments, the user device 102 may store the shipment related information on a local database or on the user device 102 when the user device 102 is connected to a cellular network 109. In some embodiments, the user device 102 may send a portion of the shipment related information when the user device 102 is connected to a cellular network 109. In some embodiments, the user device 102 may transfer all shipment related information to the server computer 114 when the user device is connected to a cellular network 109.

At step 720, the server computer 114 may receive the shipment related information comprising one or more types of items, and a total number of items being shipped. At step 730, the server computer 114 causes the user device 102 to generate one or more user interfaces based on the total number and types of items to capture one or more shipper images of one or more items in a shipping package prior to the one or more items being shipped to a receiver. In other embodiments, the shipper application 103 that was configured by the server computer 114 may cause the user device 102 to generate one or more user interfaces based on the total number and types of items to capture one or more shipper images of one or more items in a shipping package prior to the one or more items being shipped to a receiver. At step 740, the server computer 114 may receive one or more shipper images and the shipment related information. At step 750, a recipient application 105 that was provided by the server computer 114 may capture one or more recipient images of the one or more items in the shipping package to determine the condition of the one or more items after being shipped to a recipient.

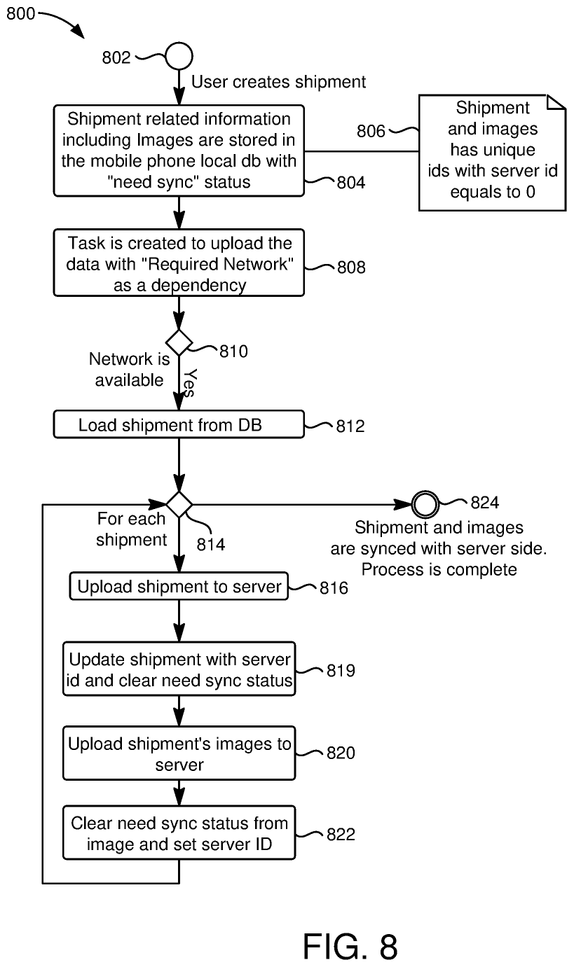

FIG. 8 illustrates a process 800 that may be used by the shipment verification system 100 in FIG. 1. As shown in FIG. 8, the process 800 may begin at step 802 with the user on a user device 102 initiating to create a shipment. Next at step 804, the shipment related information including images are stored on the user device 102 in a local database with a “need sync” status flag. In some embodiments, at step 804 the user device 102 may be configured to transfer a portion of the shipment related information to the server computer 114 while the user device 102 is connected to a cellular network 109. In this embodiment, the portion of the shipment related information that is not transferred when the user device 102 is connected to the cellular network 109 is transferred to the server computer 114 when the user device 102 connects to the Wi-Fi router 108. At step 806, the shipment and the images may have unique identifier with server identifier equaling none or zero so that the user device 102 remembers to send the images and the shipment information at a later time period. At step 808 a task may be created to upload the data with the required network connection as a dependency. At decision step 810 the user device 102 may be configured to determine whether the network is available. If the network 110 is available via a Wi-Fi router 108, then the process for uploading shipment related information with all related user images to the database server 118 begins at step 812.

At decision step 814, for each shipment with a status set to “needs sync” from step 804 the shipment related information including the images are to be uploaded to the server computer 114 at step 816. At step 819, the server computer confirms receipt of the unique shipment identifier and sends a message to clear the “need sync” status from the user device 102. After receiving the unique shipment identifier, the shipment images may be uploaded to the server computer 114 and stored in database server 118, at step 820. Next at step 822, the server computer 114 may clear the need sync status from each image that was locally stored on the user device 102 and set a server identifier for each image. Next the process repeats back to step 814 until each of the shipments are synchronized between the user device 102 and the server computer 114 and the database server 118. Once all shipment related information is uploaded to the database server 118 the process goes to step 824 where the shipment and images are synced with server side and the process is completed.

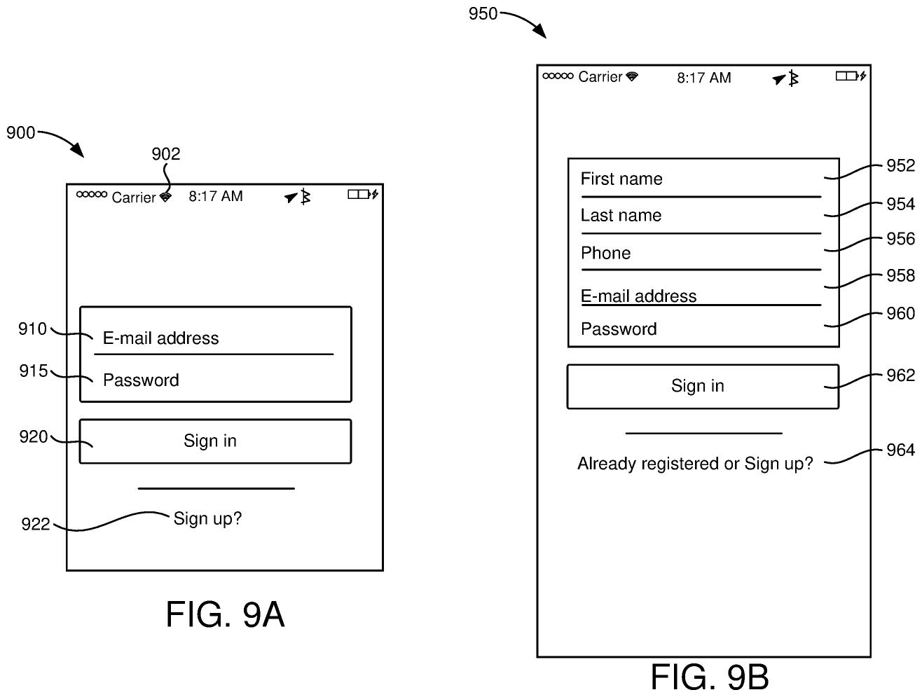

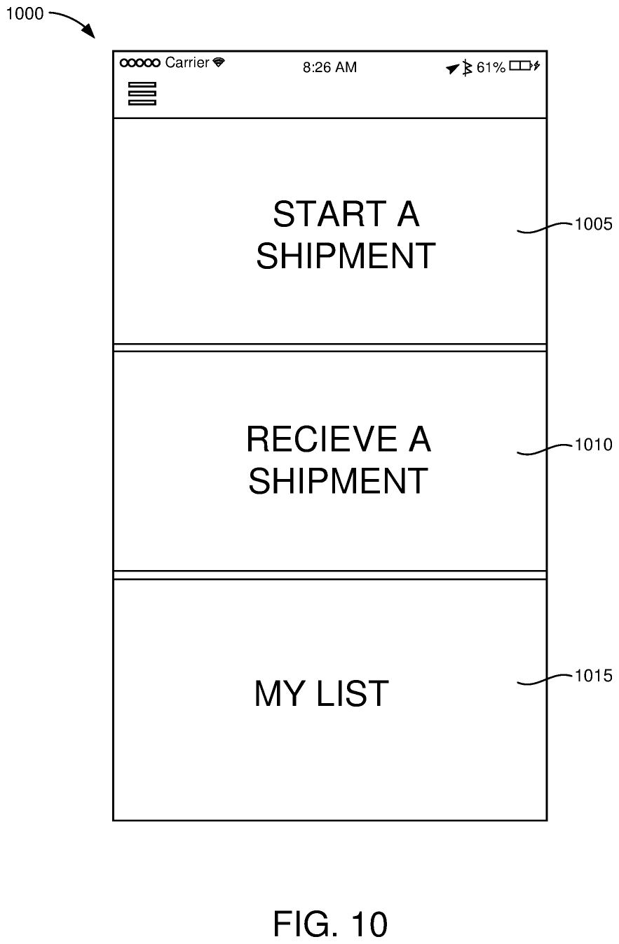

FIG. 9A is a user interface display 900 of an application implemented using the system 100 shown in FIG. 1. For example, display 900 may be shown by a user device 102 to help the user provide the appropriate information for the registered user to sign into the shipper application 103 or recipient application 105. Moreover, as shown in display 900 by the Wi-Fi indicator 902, the user device 102 may be connected to the Wi-Fi router 108. In other embodiments, the user may be able to sign in without the user being connected to any network since the user's login details may be stored on the user devices 102, 104 and 106. User name field 910 may request the user's user name. In the example, shown in FIG. 9A, the username requested is an e-mail address. In password field 915, the user's password is requested. The sign in button 920 may be activated via a user interface (e.g., touch, mouse, electronic pen, etc.). Upon the user selecting the sign in button 920, the user device 102, 104 or 106 may verify the user's credentials against the previously provided credentials. After verifying the user credentials the user interface from FIG. 10 may be displayed. Also shown in the user interface display 900 is the sign up button 922 which allows a user to register for an account as shown in FIG. 9B. In other embodiments, the username and password that are entered by the user may be verified by the server computer 114 and then the user is permitted to login.

FIG. 9B is a user interface display 950 of an application implemented using the shipment verification system 100 shown in FIG. 1. As shown in display 950, the user may enter their first name in the first name field 952. The user may enter their last name in the last name field 954. The user may enter their phone number in the phone field 956. The user may enter their e-mail address in the e-mail address field 958. The system may use the user's e-mail address as the user's login name. The user may enter their preferred password in the password field 960. Based on the above information the user may activate the button sign in 962 and sign in to the application. Also shown in the user interface display 950 is the sign up button 964 which allows a user to register for an account. Each of the above information may be sent to the application server 114 for storage and future verification. If the user selects the field already registered, then the user interface display 900 may be displayed from FIG. 9A. Upon registering for a new account, a confirmation e-mail will be sent to the user to confirm the email address provided.

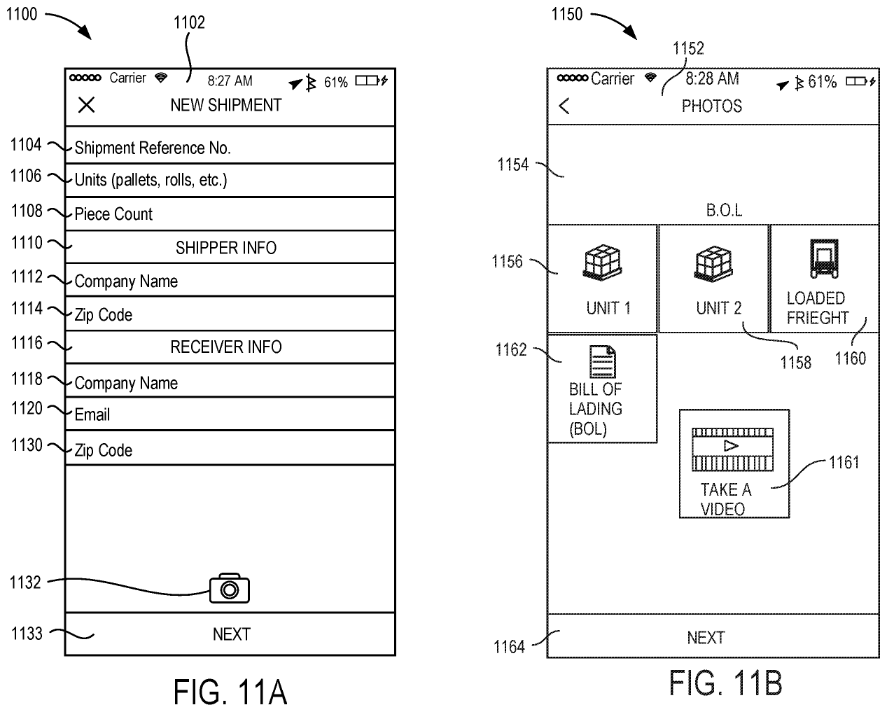

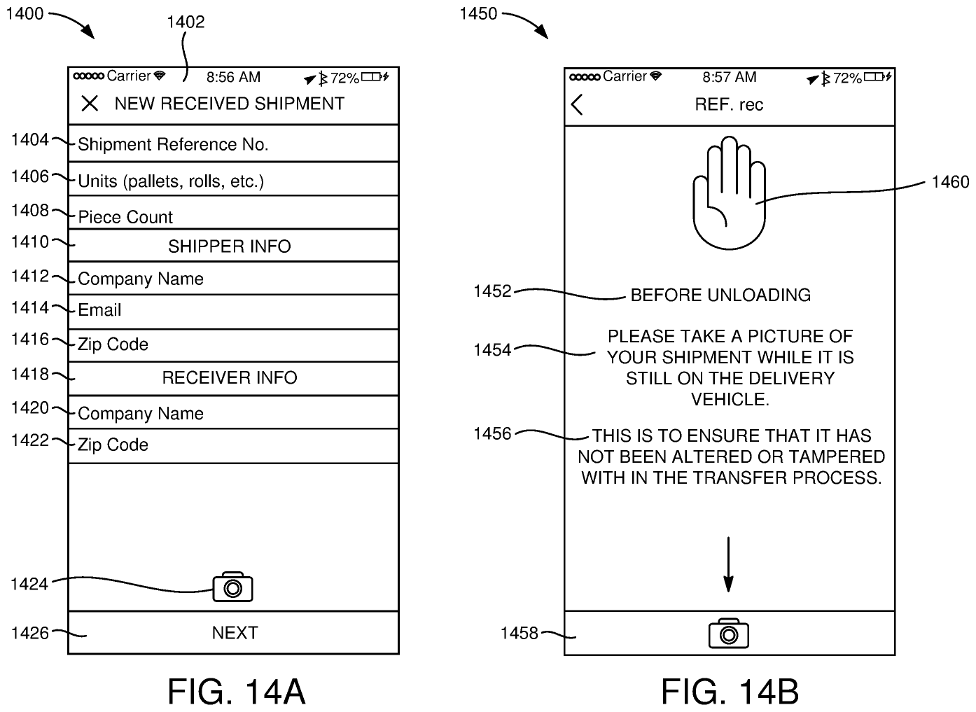

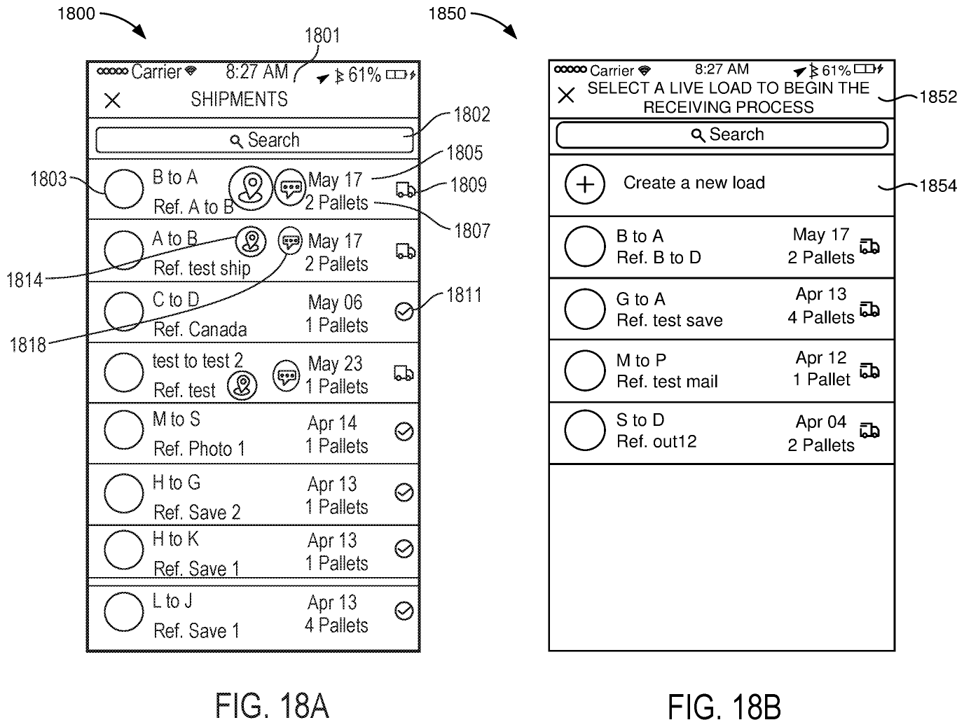

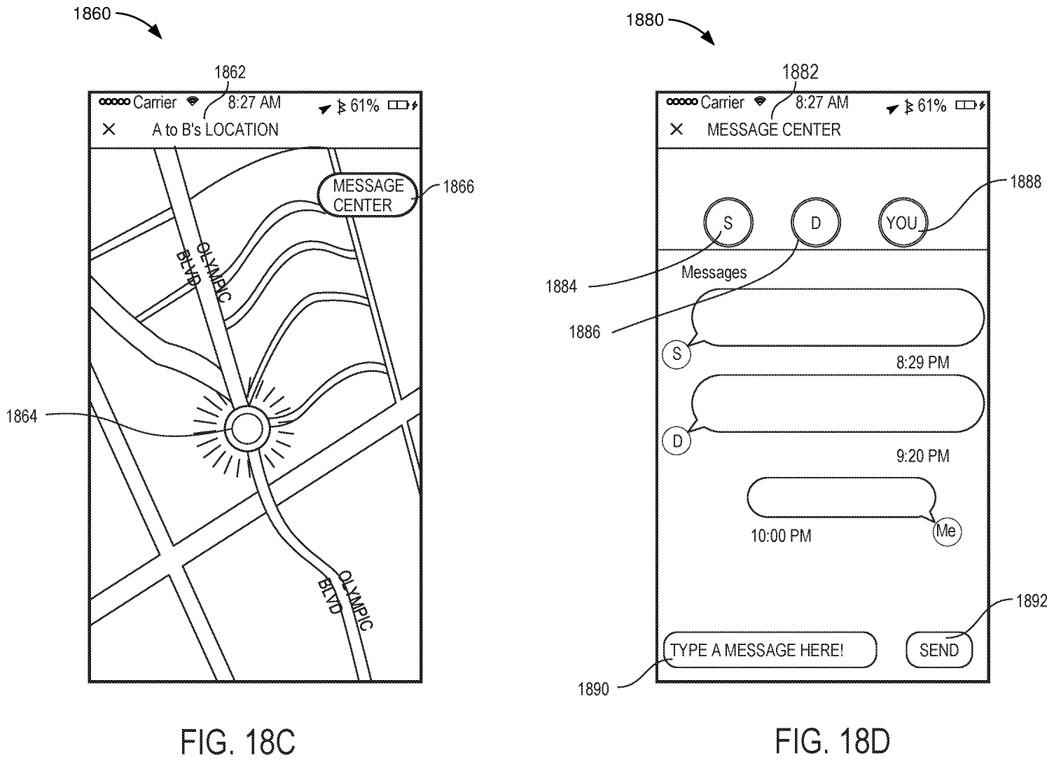

FIG. 10 is a user interface display 1000 of an application implemented using the shipment verification system 100 shown in FIG. 1. User interface 1000 has three buttons: start a shipment 1005, receive a shipment 1010 and my list 1015. If the user selects the start a shipment 1005, the user will be provided with guided user interfaces from FIGS. 11A to 13B. Selecting the start of shipment 1005 allows the user to transition to a set of views that allows the user to create a new shipment. Among other views, the shipper application 103 may generate the user interface display 1000 and the user interfaces form FIGS. 11A to 13B. Selecting the receive a shipment 1010 button allows a user to view a list of shipments that have been sent to that user or that user's company or to create a special “receive” shipment user interface as shown in FIGS. 14A through 17B. Selecting the my list 1015 button allows the user to browse the list of shipped and received shipments, including the shipments that haven't been synchronized with the server computer 114 as shown in FIGS. 18A and 18B.

FIG. 11A is a user interface display 1100 of an application implemented using the shipment verification system 100 as shown in FIG. 1. The user interface display 1000 may be shown to the user after the user selects start shipment button 1005. The new shipment user interface display 1100 includes various fields that may be filled out by the user or provided by a third party server 122. The display 1100 shows the label 1102 “NEW SHIPMENT” to provide the user guidance regarding which screen is being filled out. The shipment reference number 1104 may be automatically generated using a random number generator that takes in as input the username, time, date, etc. In some embodiments, the shipment reference number 1104 may be received from the server computer 114. In other embodiments, the shipment reference number 1104 may be generated by the user devices. Next various fields may be manually or automatically filled out by the user. Units 1106 field may identify the type of unit being shipped, such as, pallets, roll, packages, etc. Piece count 1108 field may identify the number of units included in the shipment. Shipper info 1110 is the title of the subsection that may identify the information of the shipper. Shipper info 1110 comprises of a shipper company name 1112 that may identify the name of the shipping company and shipper zip code 1114 that may include the zip code of the shipping company. Receiver info 1116 is the title of the subsection that may identify the information of the receiver. Receiver info 1116 comprises of a receiver company name 1118 that may identify the name of the receiver company, receiver e-mail 1120 that may identify the email of the receiver, and the receiver zip code 1130 that may include the zip code of the receiver company. FIG. 11A further comprises of a camera icon 1132 that allows the user to capture photos, and a next button 1133 that allows a user to proceed to further steps.

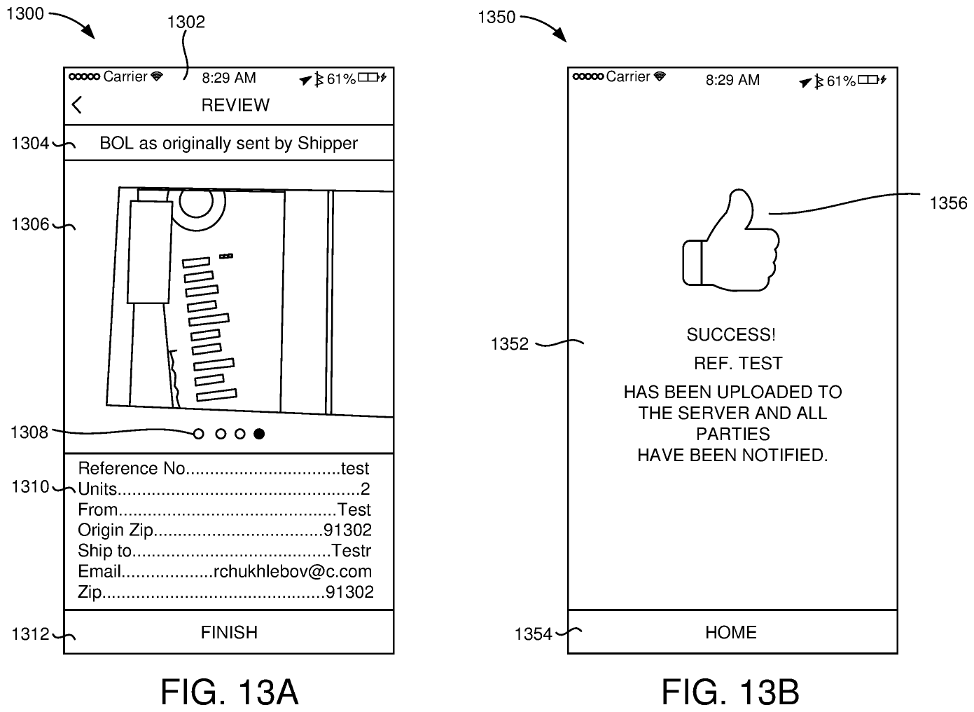

FIG. 11B is a user interface display 1150 of an application implemented using the system shown in FIG. 1. The user interface display 1150 displays a screen that allows the user to capture photos 1152. The user may select each item displayed in the user interface display 1150 to take a corresponding image. Each image may be stored on the user device 102 with a “need Sync” flag initially until the user device 102 connects to the Wi-Fi router 108. The user interface display 1150 displays portions of the screen that may be selected by the user to take images based on the inputs received from the new shipment user interface 1100. For example, if the user stated that there were two units in the shipment, then the user is offered slots to take images of the 2 units (1156 and 1158), a loaded freight image 1160, option to load a bill of lading 1162, and offered an option to upload a video 1161 that allows the other users to have a chance of seeing live footage of the packages and observe information about the driver and the truck. The text 1154 provides the user instructions such as but not limited to, tap each square in numerical order to add images, including loaded freight image and bill of lading. After the user has taken the images and documents, the color on the next button 1164 may be changed so that the user may navigate to the review screen shown in FIG. 13A.

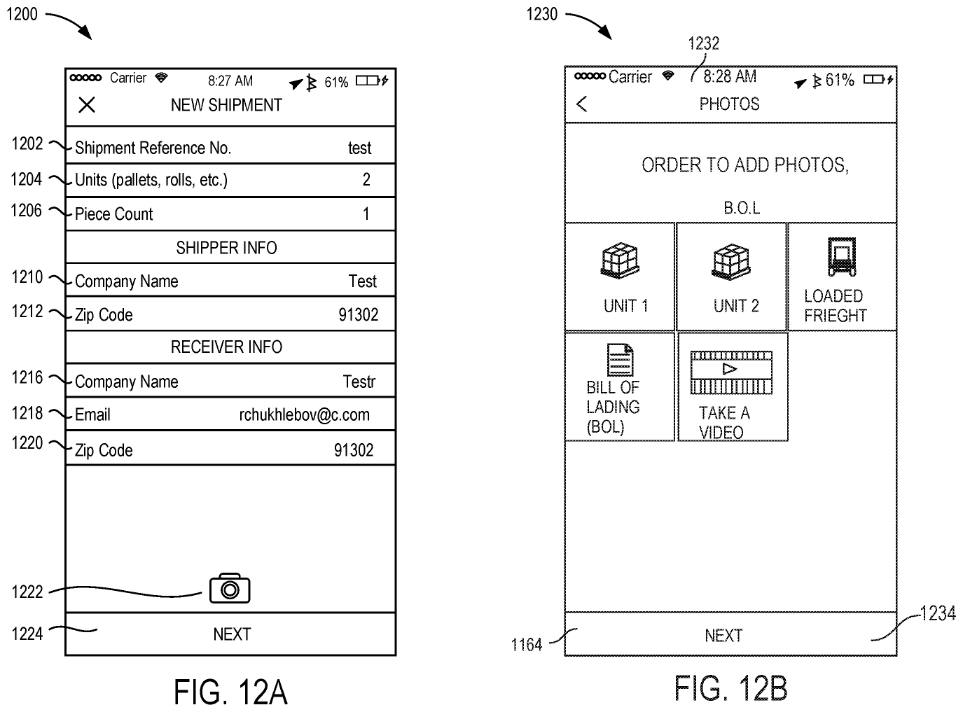

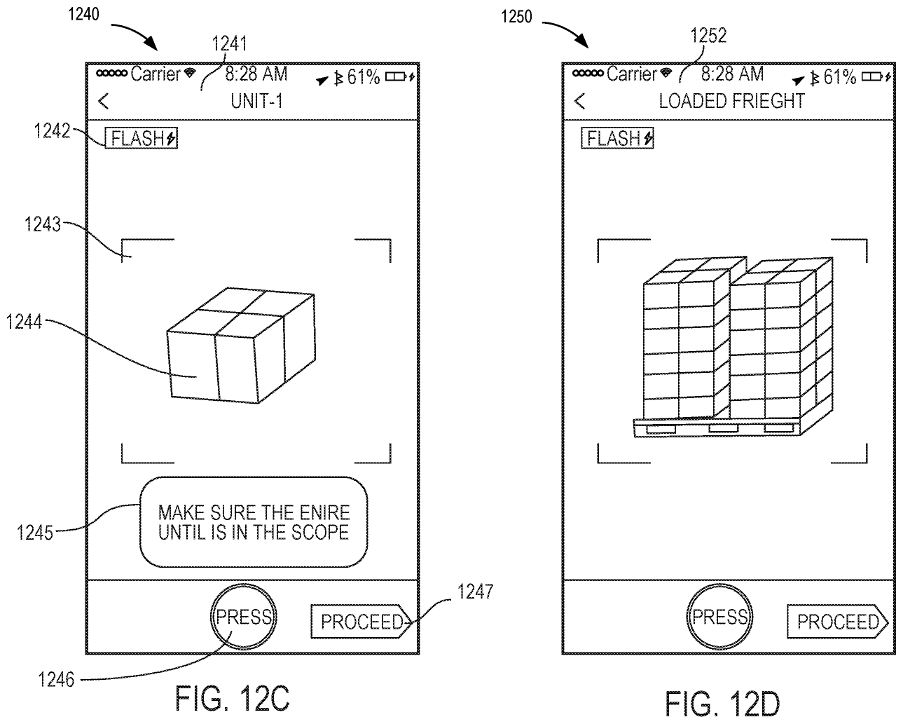

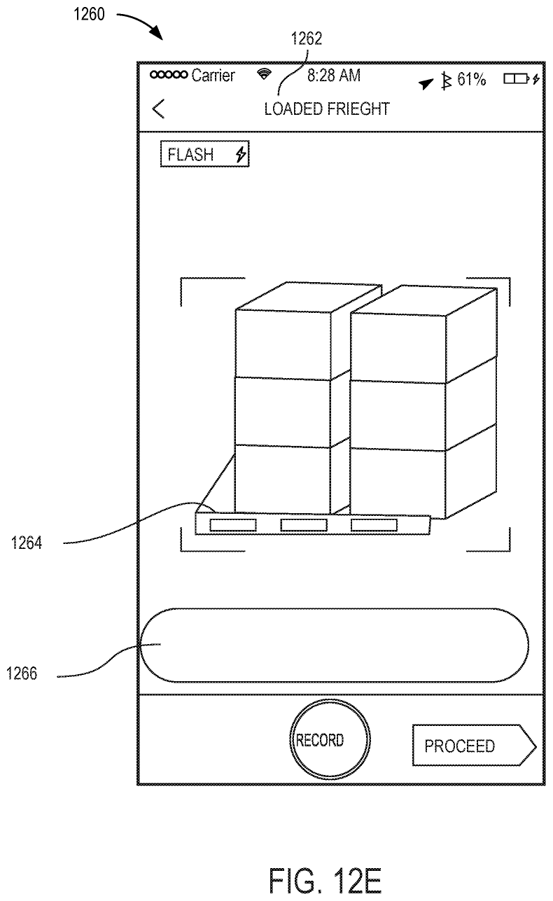

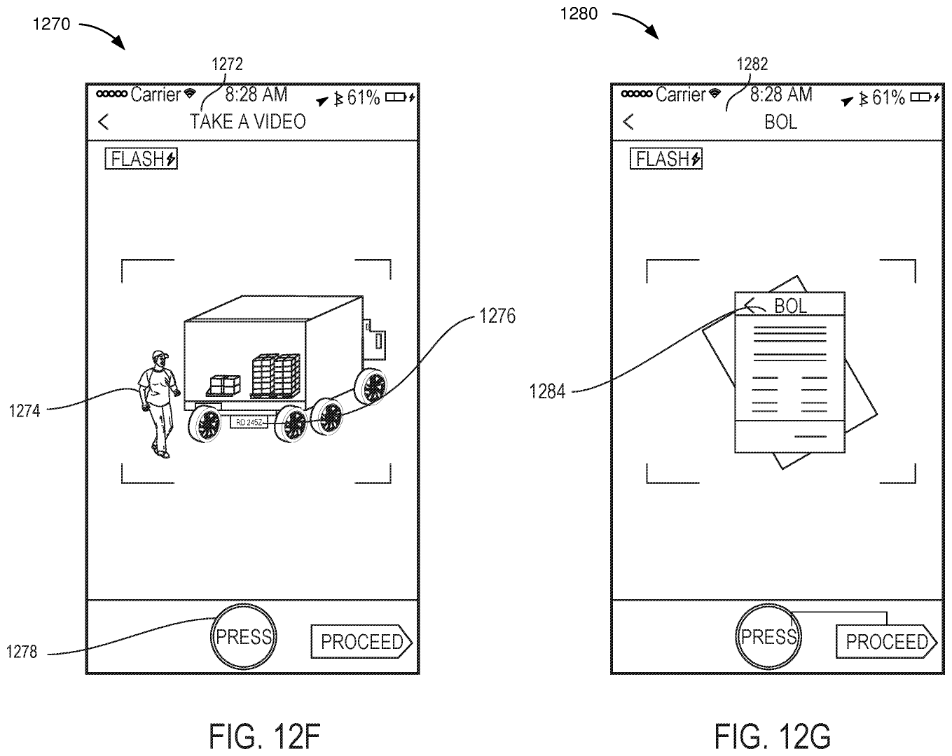

FIG. 12A is a user interface display 1200 of an application implemented using the shipment verification system 100 shown in FIG. 1. The information that is locally stored on the user device 102 may be edited, changed or deleted until the shipment has been synchronized with the server computer 114. The user interface display 1200 allows a user to navigate back and forth to edit details regarding the shipment. As shown in user interface display 1200, the displayed shipment reference number 1202 may be edited or deleted. The displayed identified unit types 1204 may be edited or deleted, and the displayed piece count 1206 may be edited, updated, or deleted. For the shipper info 1110, the displayed shipper company name 1210 may be edited, updated, or deleted. Additionally, the displayed shipper zip code 1212 may be edited, updated, or deleted. For the receiver info 1116, the displayed receiver company name 1216 may be edited, updated, or deleted. Additionally, the displayed receiver e-mail 1218 may be edited, updated, or deleted. Furthermore, the displayed receiver zip code 1220 may be edited, updated, or deleted.

FIG. 12B is a user interface display 1230 of an application implemented using the system shown in FIG. 1. The user interface display 1230 displays a screen that allows a user to navigate back and forth to edit photos 1232 regarding the already uploaded photos and videos. As shown in FIG. 12B, when all images for each box have been taken and saved, the user may be provided a chance of editing or updating the stored images and videos. In some embodiments, there are no editing limitations and the users are able to edit all information, and override various fields at all times. In other embodiments, once the images are uploaded into the system, the user is not able to edit, update, or delete images that have been already uploaded, and there are editing limitations upon the images and the videos to allow full transparency. Upon editing or not editing the provided information the next button 1164 is enabled for the user to navigate to the review screen in FIG. 13A.

FIG. 12C is a user interface display 1240 of an application implemented using the shipment verification system 100 as shown in FIG. 1. As shown in FIG. 11B, the user is offered slots to take images of the 2 units (1156 and 1158), and upon selecting either unit slots, the device's camera gets activated and the user interface display 1240 gets displayed. The unit review screen 1241 comprises various elements, such as but not limited to, a flash icon 1242, an exposure focus box 1243, camera's output 1244, text 1245, press button 1246, and the proceed button 1247. In some embodiments, the flash icon 1242 enables the user to capture images in a dark environment once the icon is pressed and activated. Upon pressing on different parts of the camera display, the user is able to move the exposure focus box 1243 around and choose the focus of the camera. Camera output 1244 displays the environment that the camera is pointing to. The text 1245 may warn the user to align the unit to reassure that the entire unit is in the scope of the camera. Upon pressing the press button 1246, the user is able to capture the image, and upon pressing the proceed button 1247, the captured picture gets uploaded on to the system for other users in the network to view. Once the pictures are uploaded on to the system, in some embodiments the user may be able to edit, update, and delete the unit pictures. In other embodiments, the user may not be able to edit, update, and delete the pictures that were just uploaded by the user using the user interface display 1240.

FIG. 12D is a user interface display 1250 of an application implemented using the shipment verification system 100 as shown in FIG. 1. As shown in FIG. 11B, the user is offered slots to take images of the loaded freight 1160, and upon selecting the loaded freight slot, the device's camera gets activated and the user interface display 1250 gets displayed. The loaded freight review screen 1252 comprises various elements, such as but not limited to the elements similar to the unit review screen 1241. By using machine learning algorithms, the exposure focus box 1243 checks for edges and aligns the edges of the stacked boxes in correspondence to the edges of the pallet that they are placed upon. If the edges are properly aligned, no errors get displayed. However, if the algorithm finds mismatched edges or improper box placement, it gives the user an error which is displayed in FIG. 12E.

FIG. 12E is a user interface display 1260 of an application implemented using the shipment verification system 100 as shown in FIG. 1. As shown in FIG. 12D, the user may upload a picture of the loaded freight by pressing the loaded freight 1160 slot. Upon capturing an image of the loaded freight, if the machine learning algorithm detects any sharp edges 1264, a warning error 1266 gets displayed at the bottom of the screen. The sharp edges 1264 indicate the possibility that the freight might not be properly aligned. The warning error 1266 is to notify the shipper that the freight may not be properly placed on the pallet, and this improper alignment may increase the chances of packages being displaced on the transit way which may lead to the packages getting damaged. The warning error message 1266 gives the person a chance to re-align the packages to prevent unfortunate consequences that may be caused by the improper alignment. Upon receiving the warning error 1266, the person uploading the image may choose to re-align or proceed anyway.

FIG. 12F is a user interface display 1270 of an application implemented using the shipment verification system 100 as shown in FIG. 1. As shown in FIG. 11B, the user is offered slots to take a video 1161, and upon selecting the video slot, the device's camera gets activated and the user interface display 1270 gets displayed. The video review screen 1272 comprises various elements, such as but not limited to the elements similar to the previous review screens. The record button 1278 allows the user to take a video of the truck being loaded with the packages that needs to be delivered. Such a video may provide information about the shipper or the shipment carrier 1274 and the truck's information 1276 that is transporting the packages. The information revealed from this video provides more transparency for the different parties involved. Once this video is uploaded on to the verification system 100, it allows the receiver to extract live information about the delivering services that are responsible for delivering the user's packages.

FIG. 12G is a user interface display 1280 of an application implemented using the shipment verification system 100 as shown in FIG. 1. As shown in FIG. 11B, the user is offered slots to take images of the bill of lading 1162, and upon selecting the bill of lading slot, the device's camera gets activated and the user interface display 1280 gets displayed. The BOL (Bill of Lading) review screen 1282 comprises various elements, such as but not limited to the elements similar to the previous review screens. Once the device's camera is activated, the user is able to take a picture of the package's corresponding bill of lading 1284 and upload it on to the system for the receiver to view, and for the shipper and the shipment carrier to confirm. The bill of lading 1284 is a contract between the shipment carrier and the shipper, and it is a receipt of freight services. Once a picture of this document is uploaded on to the verification system 100, the receiver is provided with all the information about the freight shipment and the corresponding invoices. The Bill of Lading 1284 provides information transparency for the receiver, the shipment carrier, the shipper, the manufacturer and all other involved parties.

FIG. 13A is a user interface display 1300 of an application implemented using the shipment verification system 100 shown in FIG. 1. The review screen 1302 comprises various elements, such as but not limited to, BOL title 3104, image review screen 1306, image scroller 1308, data review screen 1310 and the finish button 1312. The review screen 1302 allows the user to review the images and shipment information and navigate back to other screens and make corrections. In some embodiments, pressing the finish button 1312 may put the shipment related information into a state that it can be synchronized with the server computer 114. Once the shipment enters the synchronized state, the shipment related information can no longer be edited because the user may be locked out from editing. In other embodiments, pressing the finish button 1312 puts the shipment related information into a state where the data may be synchronized with the server computer 114 or the data may be edited using the user interfaces displays shown in FIGS. 12A and 12B.

FIG. 13B is a user interface display 1350 of an application implemented using the shipment verification system 100 shown in FIG. 1. Display 1350 is shown to the user when the shipment information has been uploaded to the server computer 114. Display 1350 lets the user know that the shipment has been processed by message 1352 and a thumbs up icon 1356. If the Wi-Fi connection is available, the shipment related information will begin synchronizing with the server by uploading each image and saving the images on the server computer 114. Once all of the images have been uploaded, the shipment information itself will be saved and the shipment will be marked as synchronized. Once the shipment is synchronized with the server, the receiver will receive an e-mail and will be able to view the images from the original shipment on their user device 104. Accordingly, if the shipper realizes that there is an issue with one or more shipment images, the shipper may be able to inform the shipment carrier and get the issue fixed or the shipment recalled back to the shipper. Selecting the home button 1354 will display the initial screen to the user and takes the user back to the home screen shown in FIG. 10.

FIG. 14A is a user interface display 1400 of an application implemented using the shipment verification system 100 shown in FIG. 1. The user interface display 1400 may be implemented by the recipient application 105. The receiver of the shipment may have a similar flow as the shipper with a few differences. The new received shipment review screen 1402 allows the users to receive shipments that were not sent using the shipment verification system 100 and still utilize the services of system 100. If the shipment was not generated by the shipment verification system 100, the system may be configured to generate a new shipment reference number 1404. The user may enter the type of units 1406, such as but not limited to, pallets, rolls, packages, boxes, etc. The total number of pieces 1408. The user may be asked for shipper information 1410. The shipper information includes the shipper's company name 1412, shipper's email address 1414, and shipper's zip code 1416. Additionally, the shipment verification system 100 may request the receiver's information 1418. The receiver's information may include the receiver's company name 1420 and the receiver's zip code 1422. A camera icon 1424 is shown on the user interface display 1400 to indicate that if the user selects the next button 1426, then the next user interface displays 1450, 1500, 1550 allow the user to select and capture images will be displayed.

FIG. 14B is a user interface display 1450 of an application implemented using the shipment verification system 100 shown in FIG. 1. User interface display 1450 display the message 1452 that informs the user to wait before unloading and provides further instructions 1454, message 1456, and the stop hand icon 1460 to grasp the attention of the user. In particular, the message 1452 states “please take a picture of your shipment” while it is still on the delivery vehicle. Message 1456 informs the user to ensure that the shipment has not been altered or tampered with during the transfer process. Images taken by the shipper and the recipient ensure end to end pictorial tracking of the package. The recipient is offered the option to compare the images from the shipper with the shipment as received. A camera button 1458 allows the user to take images of the package or display user interface 1500.

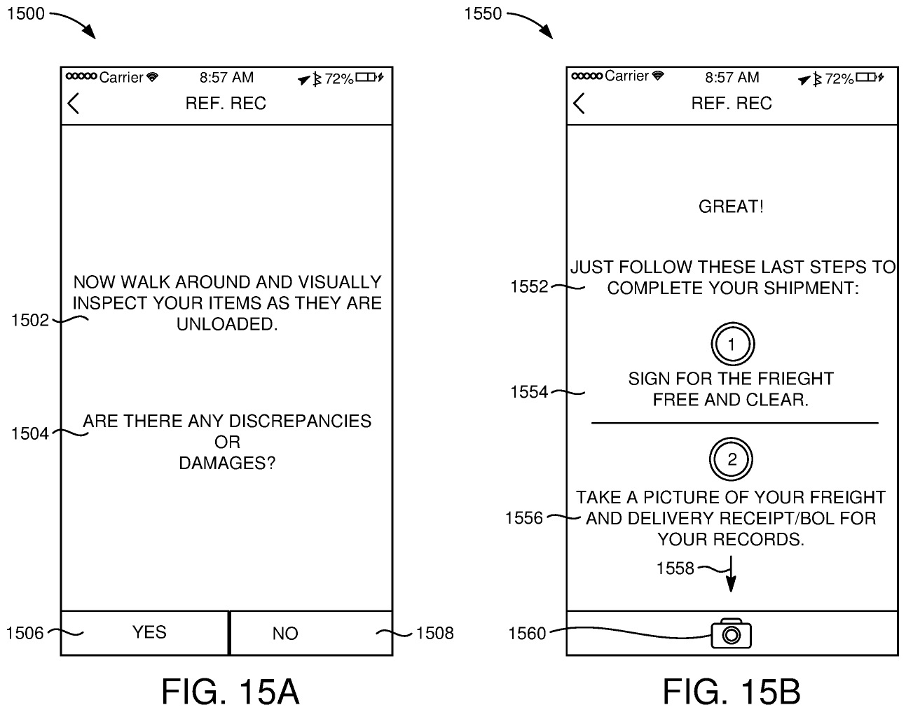

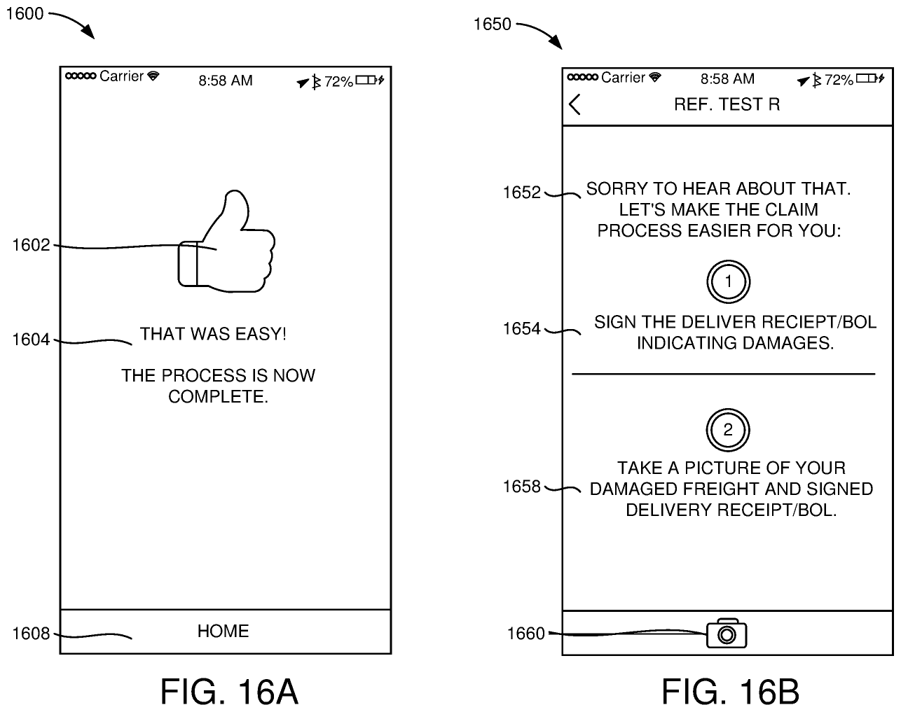

FIG. 15A is a user interface display 1500 of an application implemented using the shipment verification system 100 shown in FIG. 1. User interface display 1500 allows the user to indicate whether there was any damage during the delivery process, selecting a button will set a corresponding state of the shipment and store it on the user's device. Next the received information may be synchronized with the server computer 114. In user interface display 1500 the user is provided with instructions 1502 to walk around and visually inspect the shipped items as they are unloaded. Question 1504 may ask the user whether there are any discrepancies or damage to the shipped packages. If the user selects yes 1506, then the process may skip to user interface display 1650 from FIG. 16B. If the user selects the button no 1508, then user interface display 1550 may be shown to the user with messages to the user.

FIG. 15B is a user interface display 1550 of an application implemented using the shipment verification system 100 shown in FIG. 1. User interface display 1550 is the no damage to package flow. When there is no damage, the process flow instructs the user to proceed to take the remaining photos. The number of items/images equals the number of items that were indicated in the new shipment user interface display 1100 from FIG. 11. User interface display 1550 displays messages 1552, 1554 and 1556. Message 1552 requests that the user follow a few last steps to complete the receiving of the shipment. First message 1554 requests the user to sign for the freight free and clear. Next, message 1556 requests the user to take an image of the freight and delivery recipient bill of lading for the recipient's record. The camera icon 1560 will display a screen that allows the user to take an image of the shipment according to message 1556.

FIG. 16A is a user interface display 1600 of an application implemented using the shipment verification system 100 shown in FIG. 1. User interface display 1600 informs the user that the process was complete by displaying a thumbs up icon 1602 and a text 1604. The text 1604 is shown to inform the user that the process was easy and now the shipping process is complete. Selecting the home button 1608 will display the initial screen to the user and takes the user back to the home screen shown in FIG. 10.

FIG. 16B is a user interface display 1650 of an application implemented using the shipment verification system 100 shown in FIG. 1. User interface display 1650 is the flow that is triggered when the user indicates that there is damage to the package. The user interface display 1650 informs the user in message 1652 that the shipper is sorry to hear that the shipment is damaged and the system will make the claim process easier for the user. Next at step 1654 the user will have to sign the delivery receipt/Bill of Lading indicating the damage. Next the user is informed according to message 1658 to take an image of the damaged freight and sign the delivery receipt and bill of lading. User interface displays 1700 and/or 1750 may be displayed by selecting the take image icon 1660.

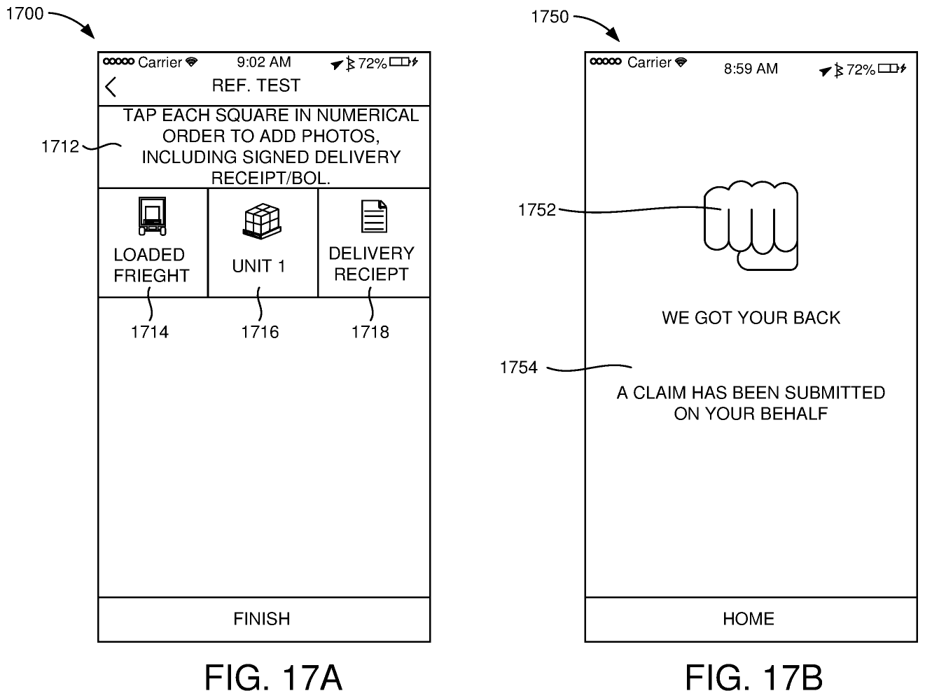

FIG. 17A is a user interface display 1700 of an application implemented using the shipment verification system 100 shown in FIG. 1. The user interface display 1700 allows the user to finish taking all of the images. When each and every image has been taken, the finish button is activated by a change of color and the user can select the finish button to complete the process. Pressing the finish button will also put the shipment in a state where it can be synchronized with the server. Initially, the user is provided a message 1712 instructing the recipient to select each square in numerical order to add images including signed delivery receipt bill of lading. By selecting the loaded freight button 1714, the user device 104 may access the camera on the device and allow the recipient to capture an image of the unloaded freight. After capturing the image the user interface display 1700 may be shown to the user and allow the user to select unit 1 button 1716. The user device 104 may access the camera on the device to capture an image of the unit 1. By selecting the delivery receipt button 1718, the recipient may view and sign the delivery receipt. After the recipient has selected buttons 1714, 1716 and 1718, the finish button may be selectable by the recipient.

FIG. 17B is a user interface display 1750 of an application implemented using the shipment verification system 100 shown in FIG. 1. The user interface display 1750 is an informational screen notifying the recipient that a claim will be submitted on the recipient's behalf to the appropriate insurance company, the shipper, the manufacturer, the shipment carrier and all other involved parties. The fisted hand icon 1752 is to reassure support and security through an icon, and the text 1754 tells the user that the claim has been successfully submitted on the user's behalf.

FIG. 18A is a user interface display 1800 of an application implemented using the shipment verification system 100 shown in FIG. 1. User interface display 1800 is shown when the user selects my list 1015 in user interface display 1000. User interface display 1800 provides a list of all shipments that the user can review, including but not limited to, new shipments in transit and received shipments. Shipment list 1801 may initially shows only the shipments stored on user device 102. In parallel, the shipper application 103 and recipient application 105 may fetch new items from the server computer 114 and refresh the list 1801 when they are successfully received from the server computer 114. Shown in the list 1801 is a search bar 1802 that allows the user to search for various shipments by name, address, date, number of units and type of items. Also shown in the user interface display 1800 is an image 1803 associated with the first shown shipment, the date 1805 and the number and type of units 1807. Also shown is the transit icon 1809 that shows that the first listed shipment is in transit. The completed icon 1811 is displayed for shipments that have been completed. Also shown in the user interface display 1800 is the shipment carrier's location icon 1814, and the message center icon 1818. Upon pressing the shipment carrier's location icon 1814, the user is able to track the location of the driver. Upon pressing the message center icon 1818, the user is able to communicate with the shipper and the shipment carrier.

FIG. 18B is a user interface display 1850 of an application implemented using the shipment verification system 100 of FIG. 1. User interface display 1850 shows a list of all shipments that are sent to the user that have not been received. The label 1852 informs the user to select an in transit load to begin the receiving process. The user can also create a new received shipment 1854 from user interface display 1850 as well. Similar to user interface display 1800, at first only local items are received while remote items are downloaded from the server computer 1850. Once an item is received, the user interface display 1850 is refreshed.

FIG. 18C is a user interface display 1860 of an application implemented using the shipment verification system 100 of FIG. 1. User interface 1860 is displayed upon pressing the shipment carrier location's icon 1814 from the user interface display 1800. The A to B's location review screen 1862 comprises of a map and a message center icon 1866. In some embodiments A may be a driver and B may be the receiver. By using Google map's open source, the shipment verification system 100 may implement maps onto the application, which allows the user to track the live specific location 1864 of the shipment carrier at all times. The user interface 1860 also calculates the distance and the estimated time from the driver A's location to the user B's location. Also shown is a message center icon 1866 that allows a user to message the shipment carrier and inform the driver in regard to any concerns.

FIG. 18D is a user interface display 1880 of an application implemented using the shipment verification system 100 of FIG. 1. User interface 1880 is displayed upon pressing the message center icon 1818 from the user interface display 1800. The message center review screen 1882 provides a communication platform for all the parties that are involved in the shipment process. The user interface display 1880 comprises various elements, such as but not limited to the shipper's representative icon 1884, the driver representative icon 1886, and the receiver representative icon 1888. Messaging subsection 1890 allows the user to write any messages or attach any files and share it with the other users involved in the shipment process. In some embodiments, the user is also offered the chance to privately message another user, without the message being displayed on the group chat for all the other users to view. Upon pressing the send button 1892, the message or the attached file will get delivered to the rest of the users in the messaging center. Upon holding down the send button for approximately 2-3 seconds, a pop up window will appear which will allow you to select the specific users that you would like the message to be privately sent to if that's the concern.

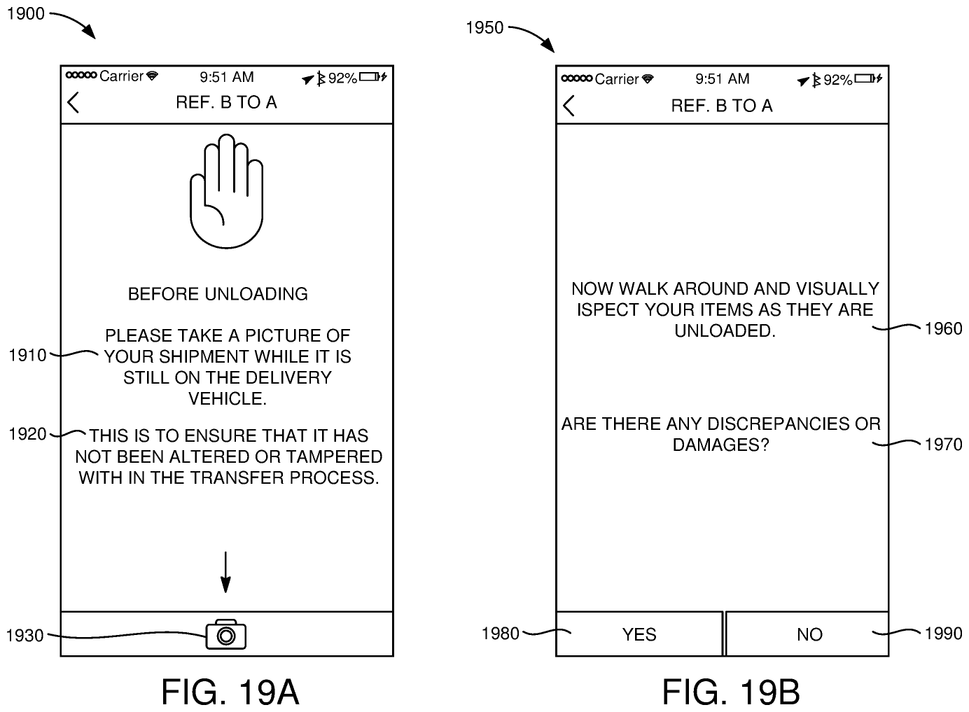

FIG. 19A is a user interface display 1900 of an application implemented using the shipment verification system 100 shown in FIG. 1. The user interface display 1900 may be a notification screen informing the user what to do to receive a shipment from FIG. 18A. Selecting the camera button 1930 may open the camera so that an image may be captured. In some embodiments, the captured image will be stored on the user's device until all information is gathered and the shipment is ready to be synchronized. The user interface display 1900 includes at least two instructions 1910 and 1920 for the user. Instruction 1910 informs the user to please take an image of the shipment while the shipment is still on the delivery vehicle. Instruction 1920 informs the user that this process ensures that the shipment has not been altered or tampered during the shipping or transfer process. Next, the user may select the camera button 1930 to take images of the shipment according to the screen displayed in FIG. 19B.

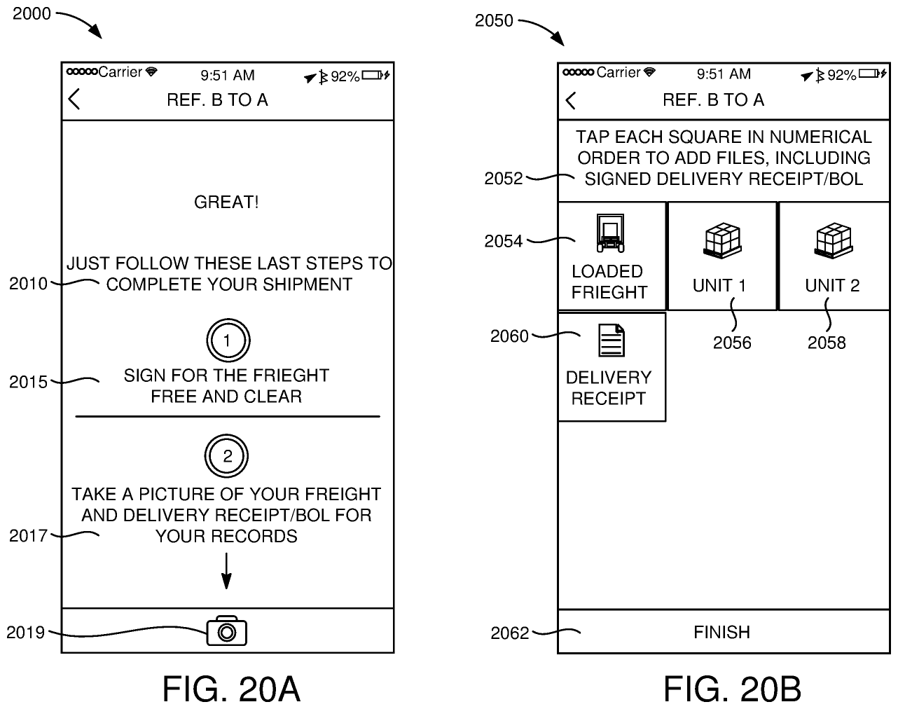

FIG. 19B is a user interface display 1950 of an application implemented using the shipment verification system 100 shown in FIG. 1. User interface display 1950 allows the user to indicate whether there was any damage during the delivery process, selecting a button will set a corresponding state of the shipment and store it on the user's device. Next the received information may be synchronized with the server computer 114. In user interface display 1950 the user is provided with instructions 1960 to walk around and visually inspect the shipped items as they are unloaded. Question 1970 may ask the user whether there are any discrepancies or damage to the shipped packages. If the user selects yes 1980, then the process may skip to user interface display 2050 from FIG. 20B. If the user selects no button 1990, then user interface display 2000 may be shown to the user with messages to the user.

FIG. 20A is a user interface display 2000 of an application implemented using the shipment verification system shown in FIG. 1. In particular, the user interface display 2000 may be shown when the user selects shipment B to A from user interface display 1900. The user interface 2000 is the no damage to shipment process flow, when there is no damage, the user is instructed to sign the receipt free and clear and proceed to take the remaining images. In particular, message 2010 informs the user to just follow a few last steps to complete the shipment. Message 2015 asks the user to sign for the freight free and clear. Message 2017 requests that the user take an image of the freight and delivery receipt and bill of lading for the user's record. Selecting the camera button 2019 may display user interface 2050 for the user.

FIG. 20B is a user interface display 2050 of an application implemented using the shipment verification system 100 shown in FIG. 1. The user interface display 2050 allows the user to finish taking images of the shipment. The number of item/unit photos equals the number of units indicated in the new “received” shipment screen. When all images have been taken, the finish button 2062 lights up and the user can finish the process. Selecting the finish button 2062 will also put the shipment in a state where it can be synchronized with the server. Message 2052 informs the user to select each square in numerical order to add images, including signed delivery receipt for the bill of lading. Selecting the square labeled loaded freight 2054 allows the user to take an image of the freight prior to the freight being unloaded. Selecting the unit 2056 box allows the user to capture an image of the first unit. Selecting the unit 2058 box allows the user to capture an image of the second unit. Selecting the delivery receipt 2060 box allows the user to electronically sign the delivery receipt.

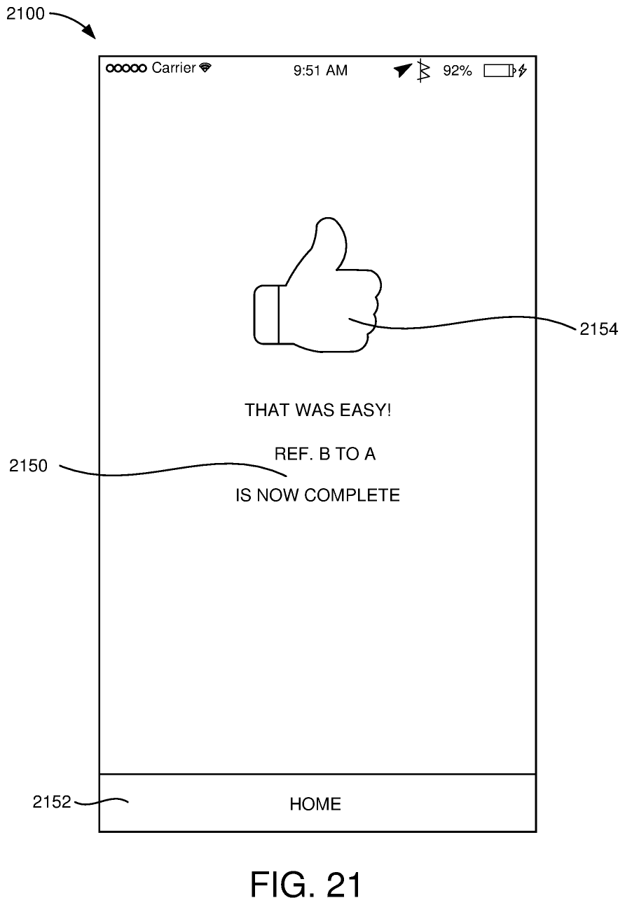

FIG. 21 is a user interface display 2100 of an application implemented using the shipment verification system 100 shown in FIG. 1. User interface display 2100 is an informational screen notifying the user that everything is good and how easy it was to complete receiving ref B to A in message 2150 and a thumbs up icon 2154. Selecting the home button 2152 will display the initial screen to the user and takes the user back to the home screen shown in FIG. 10.

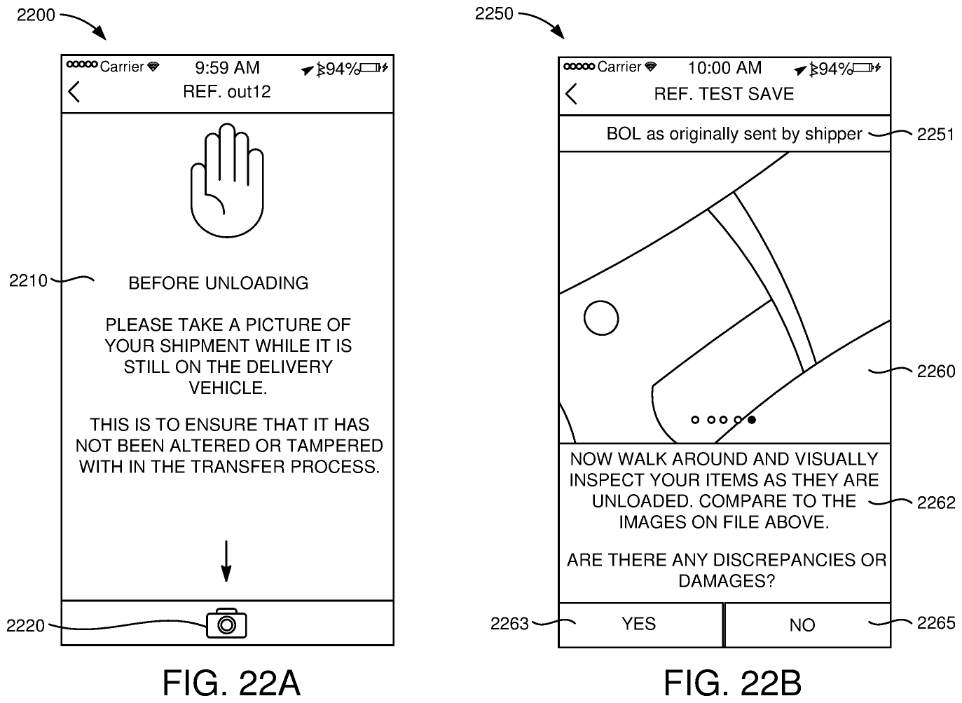

FIG. 22A is a user interface display 2200 of an application implemented using the shipment verification system 100 shown in FIG. 1. The user interface display 2200 is a notification screen informing the user the action to take prior to unloading the shipment using a message 2210. Selecting the camera button 2220 may open the camera so a picture can be taken. The picture will be stored on user's device 104 until all of the information is gathered and the shipment is ready to be synchronized.

FIG. 22B is a user interface display 2250 of an application implemented using the shipment verification system 100 shown in FIG. 1. The user interface display 2250 allows the user to review the BOL 2251 as originally sent by the shipper and images 2260 taken by the shipper and compare them to the arrived shipment to make a decision on whether there is any visible damage. The recipient may be asked to walk about and visually inspect the shipment as it is unloaded and asked if there are any discrepancies or damage by message 2262. The user may select yes 2263 or no 2265. If the user selects yes 2263, then the program triggers the damage recordation process. If the user selects no 2265, then the program triggers the no damage process flow.

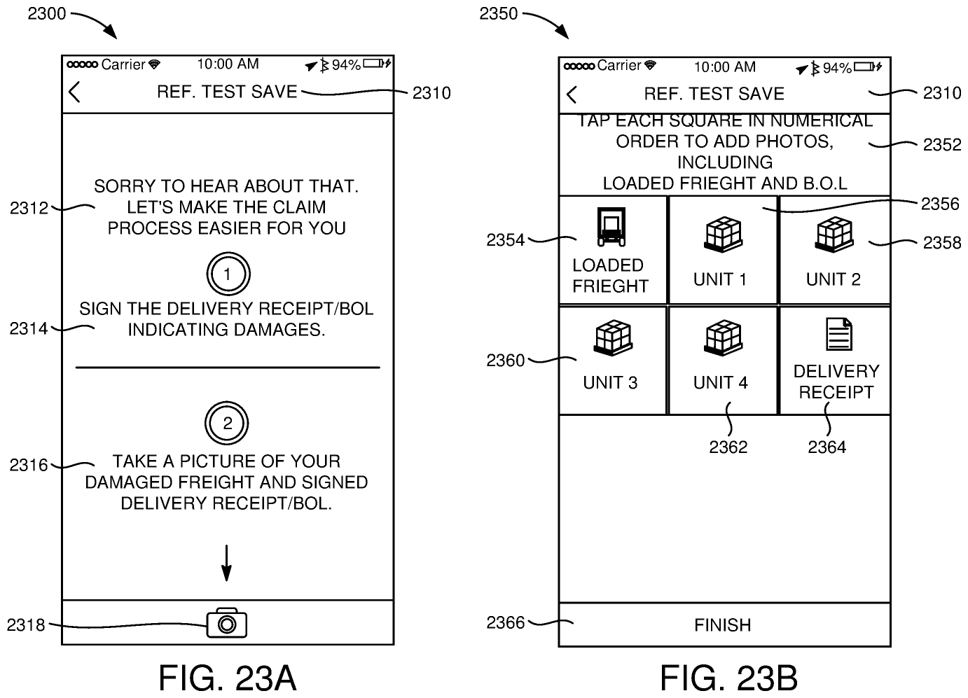

FIG. 23A is a user interface display 2300 of an application implemented using the shipment verification system 100 shown in FIG. 1. When there is damage, we instruct the user to take a picture of the damaged freight 2314 and sign delivery receipt and bill of lading 2316. The camera button 2318 may be selected to allow the user to capture the images.

FIG. 23B is a user interface display 2350 of an application implemented using the shipment verification system 100 shown in FIG. 1. The user interface display 2350 includes identifies the shipment at the top of screen at label 2310. The user interface display 2350 provides instructions 2352 to the user to top each square in numerical order to add images, including loaded freight and bill of lading. The user interface display shows a loaded freight box 2354, a unit 2356 box, a unit 2358 box, a unit 2360 box, a unit 2362 box and a delivery receipt 2364 box. Selecting any of the boxes mentioned above allows the user to capture a corresponding image. When all of the images have been taken, the finish button 2366 lights up and the user can finish the process. Pressing finish button 2366 will also put the shipment in a state where it can be synchronized with the server. The total number of item/unit photos allowed to be taken equals the number of units specified by the shipper.

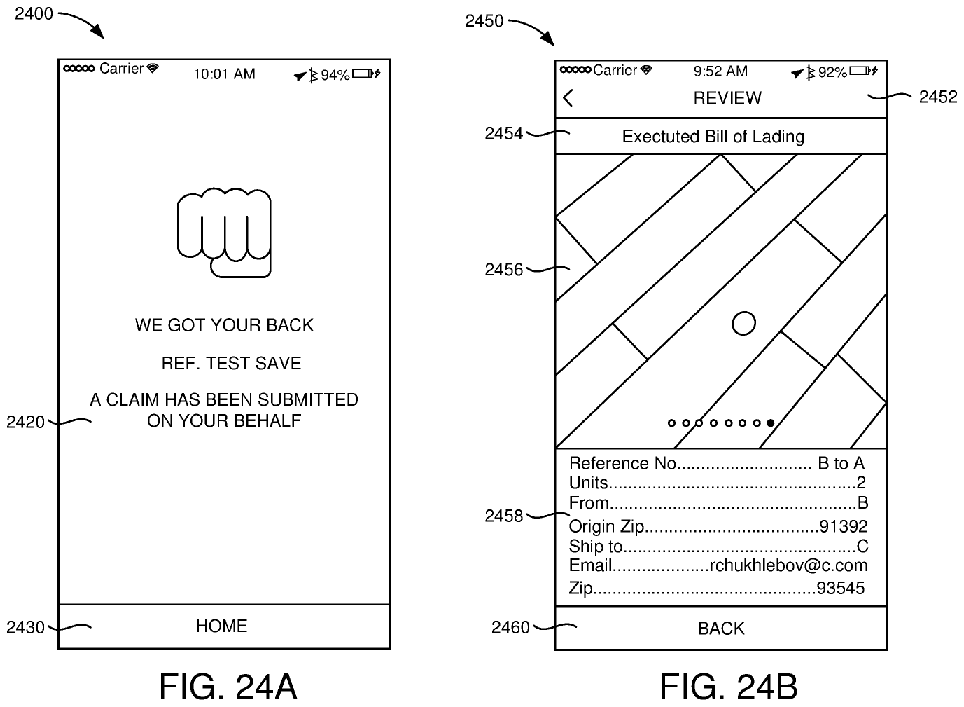

FIG. 24A is a user interface display 2400 of an application implemented using the shipment verification system 100 shown in FIG. 1. User interface display 2410 provides an informational message 2420 notifying the user that a claim will be submitted on their behalf. Pressing home button 2430 will take the user to the begin screen 1100.

FIG. 24B is a user interface display 2450 of an application implemented using the shipment verification system 100 shown in FIG. 1. The user interface display 2450 is a review screen 2452 that allows a user to select a previously received shipment from the executed bill of lading 2454 to view its information 2458 or images 2456. Lastly the user may select the back button 2460 to access the previously displayed screen.

The present disclosure contemplates methods, systems and program products on any machine-readable non-transitory storage media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule-based modules and other logic to accomplish the various connection steps, processing steps, comparison steps and decision steps.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

1. A method for verifying a shipment, the method comprising:
providing, by a server computer, a shipper application configured to store shipment related information and the shipper application configured to send shipment information to the server computer;
receiving, by the server computer, the shipment related information comprising one or more types of items, and a total number of items being shipped;
generating one or more user interfaces based on the total number and types of items to capture one or more shipper images of one or more items in a shipping package prior to the one or more items being shipped to a receiver;
receiving, by the server computer, the one or more shipper images and the shipment related information;
providing, by the server computer, a recipient application that is configured to capture one or more recipient images of the one or more items in the shipping package to capture the condition of the one or more items after being shipped to a recipient.

2. The method of claim 1, further comprising providing the one or more shipper images to the recipient application to permit the recipient to compare with the condition of the one or more items after being shipped to the recipient.

3. The method of claim 1, further comprising sending the shipment information and the shipper images to the server computer subsequent to a shipper user device connecting to a Wi-fi network.

4. The method of claim 1, further comprising receiving by a server computer the one or more recipient images.

5. The method of claim 4, further comprising, the server computer configured to compare the one or more shipper images with the one or more recipient images.

6. The method of claim 5, wherein the recipient images are only received by the server computer when a recipient user device is connected to a Wi-Fi network.

7. The method of claim 1, wherein the shipment information is stored on a shipper device prior to the shipper device connecting to a Wi-Fi network.

8. The method of claim 1, wherein the shipping package is at least one of a box, pallet or container.

9. An apparatus for verifying a shipment, the apparatus comprising:
a user device with a shipper application, provided by a server computer system, that is configured to receive shipment related information to send to a server computer system;
wherein the shipment related information comprises one or more types of items, a total number of items being shipped and one or more shipper images of one or more items that are part of the shipment;
an image capture device communicatively coupled to the user device to capture the one or more shipper images of the one or more items;
wherein the shipper application is configured to store at least a portion of the shipment related information on the user device until the user device is connected to a Wi-Fi network.

10. The apparatus of claim 9, wherein the user device is configured to transfer the shipper images only after the user device is connected to the Wi-Fi network.

11. The apparatus of claim 10, wherein the user device is configured to transfer textual shipment related information to the server computer system via cellular network before connecting to the Wi-Fi network.

12. The apparatus of claim 9, wherein the user device is configured to transfer text data related to the shipper images via a cellular network as the images are captured.

13. The apparatus of claim 12, wherein the user device is configured to transfer the shipper images only when the user device is connected to the Wi-Fi network.

14. The apparatus of claim 10, a recipient user device having a recipient application is configured to receive the shipper images in order to compare the shipper images to the items that were shipped.

15. The apparatus of claim 14, a recipient user device having a recipient application is configured to capture images of the shipment upon receipt of the shipment.

16. The apparatus of claim 15, further comprising, the server computer configured to compare the one or more shipper images with the one or more recipient images.

17. A method, comprising:
providing, by a server computer, a shipper application configured to store shipment related information and send shipment information to a server when the user device is connected to Wi-Fi network;
receiving, by the server computer, the shipment related information comprising one or more types of items, and a total number of items being shipped;
generating one or more user interfaces based on the total number and types of items to capture one or more shipper images of one or more items in a shipping package prior to the one or more items being shipped to a receiver;
receiving, by the server computer, the one or more shipper images and the shipment related information; and
providing, by the server computer, a recipient application that is configured to capture one or more recipient images of the one or more items in the shipping package to capture the condition of the one or more items after being shipped to a recipient.

18. The method of claim 17, further comprising providing an application to a user device wherein the application is configured to store shipment related information on the user device to be uploaded to a server subsequent to all required fields of the shipment information being received on the user device.

19. The method of claim 18, wherein the shipping package is at least one of a box, pallet or container.

20. The method of claim 1, further comprising providing the one or more shipper images to the recipient application to permit the recipient to compare with the condition of the one or more items after being shipped to the recipient.
